(19) United States
(12) Patent Application Publication
(10) Pub. No.: US 2019/0295011 A1
(43) Pub. Date: Sep. 26, 2019

(54) DISTRIBUTED COMPUTER FRAMEWORK FOR DATA ANALYSIS, RISK MANAGEMENT, AND AUTOMATED COMPLIANCE

(71) Applicants: Xingjian Duan, New York, NY (US); Yan Shi, New York, NY (US)

(72) Inventors: Yan Shi, Jericho, NY (US); Xingjian Duan, Sunnyvale, CA (US)

(21) Appl. No.: 16/358,641

(22) Filed: Mar. 19, 2019

Related U.S. Application Data
(60) Provisional application No. 62/645,741, filed on Mar. 20, 2018.

(51) Int. Cl. G06Q 10/06; G06F 17/50; G06F 16/25; G06F 3/0483

(52) U.S. Cl. CPC G06Q 10/067; G06F 3/0483; G06F 16/254; G06F 17/5009

(57) ABSTRACT

Introduced here are risk management platforms able to implement an automated framework designed to manage, parse, and analyze data for purposes of facilitating compliance with relevant policies in a distributed computer environment. By implementing the technology described herein, an entity can ensure that it complies with the latest regulatory policies, recognizes emerging risks, and conducts more efficient operational planning. A risk management platform can generate interfaces through which an individual (also referred to as a “user”) can interact with the risk management platform. Through these interfaces, the user can apply programmed models to financial data associated with an entity to predict the performance of the entity under various economic scenarios.

### CROSS-REFERENCE TO RELATED APPLICATIONS

This application claims priority to U.S. Provisional Application No. 62/645,741, titled “Distributed Computer Framework for Data Analysis, Risk Management, and Automated Compliance” and filed on Mar. 20, 2018, which is incorporated by reference herein in its entirety.

### TECHNICAL FIELD

Various embodiments concern computer programs and associated computer-implemented techniques for implementing an automated framework designed to manage, parse, and analyze data for purposes of facilitating compliance with relevant policies in a distributed computer environment.

### BACKGROUND

The term “risk analysis” refers to the process of assessing the likelihood of an adverse economic event occurring within the corporate, government, or environmental sector. Risk analysis (also referred to as “risk management”) generally involves a detailed study of the underlying uncertainties associated with a given course of action. In the case of a financial institution, for example, risk analysis may involve predicting cashflow, estimating the variance of returns (e.g., from stocks and mortgages), and forecasting the future state of the economy. Historically, the individuals responsible for performing risk management (also referred to as “practitioners”) have worked in tandem with forecasting professionals to minimize the number of unforeseen events that have negative effects on the financial health of a corporate entity (or simply “entity”). However, due to the introduction of new policies and the availability of vast amounts of data, such a technique is becoming increasingly susceptible to errors.

Due to the new regulatory model for the economy, practitioners involved in analyzing the emerging risks that may affect entities must continue to re-position themselves through innovation. The goal of risk analysis is to reduce the likelihood that a high-risk event causes losses to be incurred by an entity. However, refusing to enter a business relationship due to uncertainty or fear of taking responsibility is generally not a viable option for the entity. As noted above, risk analysis has traditionally been performed by human(s), which results in decreased accuracy, reliability, consistency, clarity (e.g., in terms of reasoning), and timeliness. Even with the assistance of state-of-the-art computing devices, most risk analysis is performed in a myopic and isolated manner due to the lack of interconnectivity between the vast variety of sources of information. While these sources may be connected with one another through network(s) (e.g., private networks or public networks, such as the Internet), the pieces of information maintained by these sources cannot be connected in a meaningful way. Consequently, timely analysis of these pieces of information cannot be performed.

### BRIEF DESCRIPTION OF DRAWINGS

Various features of the technology will become more apparent to those skilled in the art from a study of the Detailed Description in conjunction with the drawings. Embodiments of the technology are illustrated by way of example and not limitation in the drawings, in which like references may indicate similar elements.

FIG. 1 depicts an example of a centralized model for performing inter-departmental, multi-hop reporting.

FIG. 2 includes a flow chart illustrating an example of an optimized technique in which a compliance framework is simultaneously employed by a financial institution alongside the day-to-day operational planning.

FIG. 3 demonstrates how, under the new rules, a financial institution may still employ pre-regulation model(s) in addition to more risk management practitioners working alongside each department.

FIG. 4 depicts an example of a decentralized model for performing inter-departmental, multi-hop reporting.

FIG. 5 illustrates the risk management operations generally shared in common across the various departments of a financial institution.

FIG. 6 depicts a flow diagram of a process for performing risk analysis on behalf of a financial institution in accordance with embodiments of the technology.

FIG. 7 includes a generalized illustration of a smart connector that is responsible for acquiring, examining, and processing data in accordance with various embodiments of the technology.

FIG. 8 includes a generalized illustration of a repository management tool designed to receive input via an interface through which users can create, modify, and delete smart connectors and their accompanying information.

FIG. 9 illustrates how a supervised machine learning technique can be used to train a predictive model to create an ETL adapter for a new model.

FIG. 10 illustrates a network environment that includes a risk management platform.

FIG. 11 includes an example of an interface that, when accessed by a user, allows the user to choose from amongst three functional modules.

FIG. 12 includes an example of an interface that may appear when the user selects the “CCAR/DFAST Production” entry under the “Functions” tab on the interface of FIG. 11.

FIGS. 13A-H include examples of interfaces that may appear when the user selects the “Scenario Analysis” entry under the “Functions” tab on the interface of FIG. 11.

FIG. 14 includes an example of an interface that may appear when the user selects the “Attribution Analysis” entry under the “Functions” tab on the interface of FIG. 11.

FIGS. 15A-B include examples of interfaces that may appear when the user selects the “Model Management” entry under the “Inventory” tab on the interface of FIG. 11.

FIGS. 16A-B include examples of interfaces that may appear when the user selects the “Scenario Management” entry under the “Inventory” tab on the interface of FIG. 11.

FIGS. 17A-J include examples of reports that may be produced by a risk management platform or a business intelligence tool that is communicatively connected to the risk management platform.

FIG. 18 includes a visual representation of the past financial crises that may be used by the risk management platform to prepare users for future financial crises.

FIG. 19 includes an example of an interface in which two trainees (e.g., Nancy and Bob) simultaneously consider how to guide their respective fictional financial institutions through a fictional financial crisis.

FIG. 20 includes an example of an interface through which a trainee can create a new simulation session.

FIGS. 21A-B include examples of interfaces that may appear in advance of a simulation session.

FIGS. 22A-C include examples of interfaces that may appear during a simulation session.

FIGS. 23A-L depict examples of interfaces that may be seen by an individual (John Doe) responsible for executing a risk analysis process on behalf of a financial institution.

FIGS. 24A-I include examples of results that have been made available through a business intelligence tool (here, Power BI® and Tableau®).

FIG. 25 is a block diagram illustrating an example of a processing system in which at least some operations described herein can be implemented.

The drawings depict various embodiments for purposes of illustration only. Those skilled in the art will recognize that alternative embodiments may be employed without departing from the principles of the technology. Accordingly, while specific embodiments are shown in the drawings, the technology is amenable to various modifications.

### DETAILED DESCRIPTION

Introduced here are risk management platforms able to implement an automated framework designed to manage, parse, and analyze data for purposes of facilitating compliance with relevant policies in a distributed computing environment. By implementing the technology described herein, an entity can ensure that it complies with the latest regulatory policies, recognizes emerging risks, and conducts more efficient operational planning. As further described below, a risk management platform can generate interfaces through which an individual (also referred to as a “user”) can interact with the risk management platform. Through these interfaces, the user can develop/apply models to data associated with an entity. The user may be a practitioner employed by, or working on behalf of, the entity.

Initially, the user can upload programmed model(s) (or simply “models”) designed to facilitate predictive economic forecasting to the risk management platform, as well as the data needed by the model(s) as input. For example, the user may upload one or more financial statements associated with the entity, and the risk management platform may parse the financial statement(s) to establish cashflow, holdings in high-risk categories, cash in hand, etc. Based on this information, the risk management platform can automatically assess the risk position of the entity under various economic scenarios. In some embodiments, the risk management platform allows the user to further define these economic scenarios by specifying macroeconomic, microeconomic, or industry-specific characteristics. Thus, the user can assess the potential impact of a slowing in a particular market segment (e.g., the commercial real estate market) on the entity's available capital, loan level, interest margin, liquidity position, or return on capital. Such knowledge may enable the entity to preemptively take the appropriate action(s) to address vulnerabilities.

Embodiments may be described with reference to particular entities, computer programs, system configurations, networks, etc. However, those skilled in the art will recognize that these features are equally applicable to other entity types, computer program types, system configurations, network types, etc. For example, although embodiments may be described in the context of models designed to measure regulatory compliance by a financial institution, the relevant features may be similarly applicable to models to be applied to entities in other industries, such as insurance, pharmaceuticals, gaming, etc.

Moreover, the technology can be embodied using special-purpose hardware (e.g., circuitry), programmable circuitry appropriately programmed with software and/or firmware, or a combination of special-purpose hardware and programmable circuitry. Accordingly, embodiments may include a machine-readable medium having instructions that may be used to program a computing device to perform a process for acquiring financial data associated with a given entity, determining a compliance state based on the financial data, applying a model to the financial data, predicting a future economic health state of the given entity based on the output produced by the model, etc.

### Terminology

References in this description to “an embodiment” or “one embodiment” means that the particular feature, function, structure, or characteristic being described is included in at least one embodiment. Occurrences of such phrases do not necessarily refer to the same embodiment, nor are they necessarily referring to alternative embodiments that are mutually exclusive of one another.

Unless the context clearly requires otherwise, the words “comprise” and “comprising” are to be construed in an inclusive sense rather than an exclusive or exhaustive sense (i.e., in the sense of “including but not limited to”). The terms “connected,” “coupled,” or any variant thereof is intended to include any connection or coupling between two or more elements, either direct or indirect. The coupling/connection can be physical, logical, or a combination thereof. For example, devices may be electrically or communicatively coupled to one another despite not sharing a physical connection.

The term “based on” is also to be construed in an inclusive sense rather than an exclusive or exhaustive sense. Thus, unless otherwise noted, the term “based on” is intended to mean “based at least in part on.”

The term “module” refers broadly to software components, hardware components, and/or firmware components. Modules are typically functional components that can generate useful data or other output(s) based on specified input(s). A module may be self-contained. A computer program may include one or more modules. Thus, a computer program may include multiple modules responsible for completing different tasks or a single module responsible for completing all tasks.

When used in reference to a list of multiple items, the word “or” is intended to cover all of the following interpretations: any of the items in the list, all of the items in the list, and any combination of items in the list.

The sequences of steps performed in any of the processes described here are exemplary. However, unless contrary to physical possibility, the steps may be performed in various sequences and combinations. For example, steps could be added to, or removed from, the processes described here. Similarly, steps could be replaced or reordered. Thus, descriptions of any processes are intended to be open-ended.

### Data Analysis, Risk Discovery, and Risk Management

Generally, entities perform risk analysis for defensive purposes, though such practices can also have offensive purposes. On one hand, these practices can enable an entity to build a largely indestructible line of defense against high-risk events that will affect the financial state of the entity. On the other hand, these practices can enable the entity to analyze offensive opportunities from a broader perspective. An example of an offensive opportunity is an untapped market segment or customer group. At present, the commercial environment in which entities operate is becoming increasingly complicated (e.g., due to increasing regulations), and the available profit in a highly-regulated commercial environment gradually narrows. Together, these factors have made competition between entities even more intense.

To improve upon conventional risk analysis processes, practitioners should employ innovative techniques and technologies for identifying/controlling risk, as well as their own professional skills, to identify, develop, and capture “blue oceans” in a business sense. In the daily risk management of entities, there are three common pain points: (1) information asymmetry; (2) real-time information processing requirements; and (3) costs of risk control.

Consider a financial institution as an example. First, the information that will be considered (e.g., by the practitioners in a risk control department) as part of a risk analysis process (also referred to as a “risk management process”) is often asymmetric. Even though the information belonging to the financial institution may be coherent, the information belonging to a client or a counterparty will generally be fragmented. However, the foundation of risk management lies in getting factual, effective, and complete information from all parties. Asymmetry is mainly reflected in three aspects. First, the external asymmetry of information between the financial institution and the client/counterparty. Such asymmetry primarily affects the ability to accurately grasp the true operation condition, purpose(s) of financing, source(s) of repayment, and effectiveness of management of the client/counterparty. For example, while multiple financial institutions may be financing a single enterprise at the same time, some financial institutions may retreat before default occurs while other financial institutions may wait until the enterprise files for bankruptcy. Visibly, one of the advantages of effective risk management is the ability to obtain more non-public information associated with the client/counterparty. Second, the internal asymmetry of information between (1) the business sectors and the risk control department and (2) staff and senior managers represent significant sources of risk. Third, the asymmetry of information between (1) the financial institution and its subsidiaries, (2) the main office and its branches, and (3) the entity and its subsidiaries is yet another area of concern. At present, many financial institutions tend to have complex organizational structures, wide geographical distribution, and a long management radius. All of these features tend to lead to poor transmission of risk-related information, thereby reducing the efficiency and effectiveness of risk management. In fact, in some instances, delays in transmission of risk-related information may cause the risk control department to be entirely unprepared for a high-risk event that affects the financial state of the financial institution.

Second, the risk control department may be unable to consider risk-relevant information as part of a risk management process in a timely manner. Nowadays, clients (also referred to as “customers”) have relatively high requirements on the timeliness of services provided by enterprises (e.g., financial institutions), and efficiency has become one of the major factors in inter-enterprise competition. In many cases, the time that a given project will leave for the risk control department to consider riskiness is very limited. For example, a prospective client may ask that a financial institution make a decision regarding financing within several days. Collecting enough information to produce an accurate, informed decision within a limited timeframe poses a significant challenge to the practitioner(s) in the risk control department.

Third, the costs of implementing some risk control measures may be prohibitive. Many risk control measures are effective in identifying, managing, or preventing risks, but these risk control measures cannot be put into practice due to the high cost of doing so. As an example, for creditor entities (e.g., financial institutions), it is very important to establish the authenticity of financial information related to debtor entities, the complicated relationship between entities, the relationship of implicit guarantees, and the abnormal capital transaction, but the time and labor cost are often high. As a result, many practitioners either passively accept financial information provided by an entity as truthful or conduct simple verification of financial information. This can seriously affect whether a judgement of the real risk posed by an entity (or a transaction involving the entity) is accurate.

Industries such as commercial banking have long been complex, labor intensive, less innovative, and heavily regulated. In the decade prior to the subprime mortgage crisis beginning in 2007, innovation by financial institutions (also referred to as “financial entities” or “banks”) had outpaced risk management and control capabilities. In response to the subprime mortgage crisis, significant drawback occurred in the global banking model, especially in risk management. To remedy the drawback, regulatory entities, such as the Federal Reserve Bank, implemented extremely stringent rules that forced financial institutions to reduce risky lending, institute compliance policies, and develop risk management policies. After these rules were implemented, financial institutions began to onboard a large number of employees to assist in compliance exercises. These compliance exercises increased costs for financial institutions while also suffocating the once-lucrative lending business. Nowadays, most financial institutions lack a systematic approach to risk analysis that enables them to:

1. Comply with rules imposed by regulatory agencies with less human labor; and

2. Navigate to allowable business opportunities (e.g., potential customers that are accessible via a distribution channel supported by an entity, that fit a customer profile, or that satisfy internal rules and/or investment appetite) and profitable business opportunities.

This problem is not only faced by financial institutions, but also entities in healthcare, pharmaceutical, and other similar industries. While embodiments may be described in the context of financial institutions, those skilled in the art will recognize that the features are similarly applicable to entities in other industries.

### Fundamental Problems and Associated Technical Challenges

A decade ago, most financial institutions operated in a “silo-like” manner. Said another way, most financial institutions considered limited information when deciding whether to pursue a business opportunity. For example, the main office (also referred to as the “corporate office”) may have undertaken the responsibility of gathering and reporting information despite delegating much of the decision making to its local offices or subsidiaries. Even within the corporate office, various departments may execute daily operations in silos. Each department may have their own procedures, technologies, data repositories, models, and/or reporting standards. While these siloed arrangements significantly improve intra-department efficiency, such arrangements are not designed for inter-departmental collaboration. These siloed arrangements have created significant ambiguity and information asymmetry during industry down cycles (e.g., the banking industry during the subprime mortgage crisis) and contributed significantly to the accumulation of risk and the burst of economic bubbles.

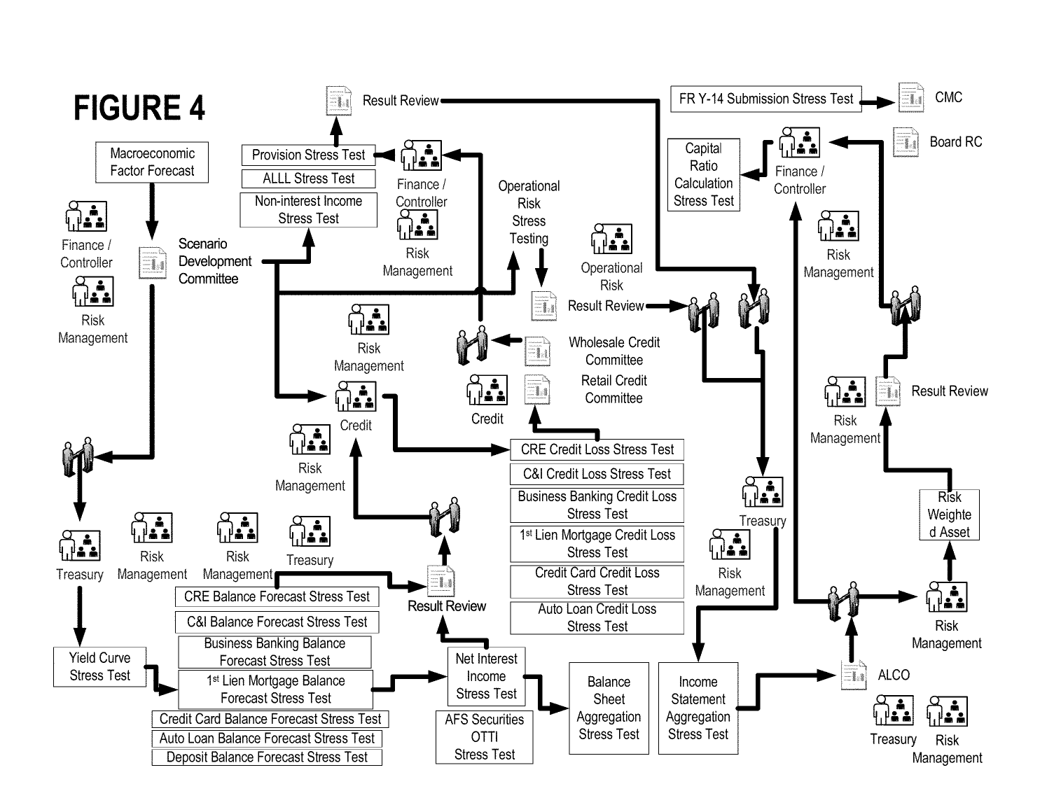

A typical inter-departmental, multi-hop reporting cycle is shown in FIG. 4, where a commercial banking scenario is used as an example. Initially, a financial institution will allocate the task of collecting and analyzing information to different functional units (e.g., the credit department, treasury department, operation risk department, etc.). Then, each functional unit will conduct the appropriate task(s) and review results in a silo-make manner. That is, each functional unit will review the results with limited consideration of inter-departmental issues. Such analytics (also referred to as “siloed analytics”) can then be collected and presented to a cross-department committee, for example, in the form of a presentation for consolidation. Inter-departmental issues are often recognized during these presentations, with feedback given back to each functional unit for additional analysis. A final decision may be made after several iterations of the analysis-feedback process. Because the completion of the process requires that multiple functional units review intermediary results several times, the process may take several months to complete.

Generally, the financial institution will require at least two months to compile a comprehensive risk report. However, this delay may cause the financial institution to be unprepared for some high-risk events. Moreover, the comprehensive risk report will be heavily reliant on human labor, and therefore nearly always full of errors and inconsistencies.

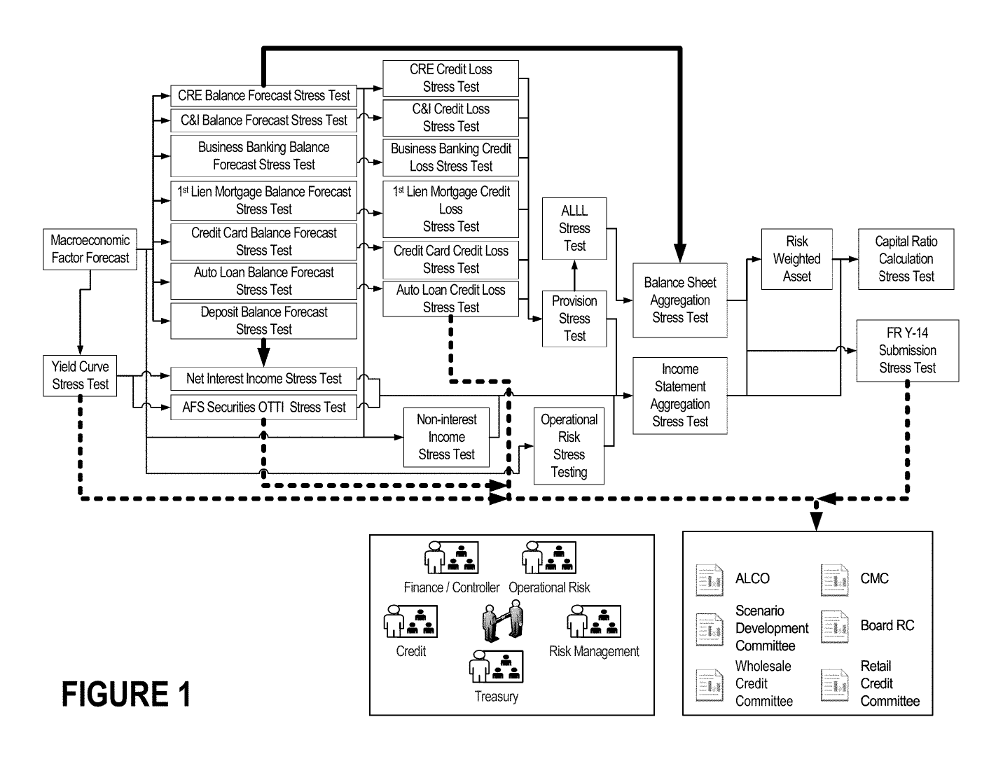

To address the information asymmetry issue described above, regulatory agencies have set forth rules that mandate covered financial institutions establish more transparent and robust risk assessment processes under a “centralized” model. While FIG. 4 illustrates a “de-centralized” model for managing risk, FIG. 1 illustrates a “centralized” model for managing risk. As shown in FIG. 1, by employing a centralized model for managing risk, a financial institution can remove some or all intermediary manual review/intervention, thereby streamlining the risk management process. The streamlined process can be automatically executed by a single computing device in a few minutes or less. The computing device can generate a series of reports (e.g., the ALCO, CMC, scenario development committee, board RC, wholesale credit committee, and retail credit committee reports) and then send these reports, either simultaneously or sequentially, to different departments (e.g., the finance/controller, operational risk, credit, risk measurement, and treasury departments). These departments can usually review the reports in no more than a couple of days. Accordingly, the multi-month process shown in FIG. 4 can be reduced to the multi-day process shown in FIG. 1.

To conform with the new regulatory paradigms, financial institutions are required to assemble information from multiple departments within a narrow window, and the finalized risk report has to show aggregated, cross-department analytics. Accordingly, these new rules have significantly increased the need to break up siloed arrangements and assess risk in a timely manner. These rules have created a clear guiding principle for financial institutions, but, at the same time, pushed practitioners involved in risk management to take shortcuts for the sake of compliance. Nearly all major regulated financial institutions have chosen to make minor tweaks to existing models, technologies, and/or systems rather than invest in designing new models, technologies, and/or systems. One reason that financial institutions have chosen this route is due to the cost and effort involved in redesigning familiar processes. The downside of a poorly-implemented redesign is the failure of the financial institution. In reality, most financial institutions have simply hired more practitioners, assigned those practitioners to work with various departments, and asked those practitioners to serve as messengers and information collectors. However, such a tactic has transformed the first pain point (i.e., information asymmetry) to the second pain point (i.e., timeliness of processing) and the third pain point (i.e., elevated compliance costs).

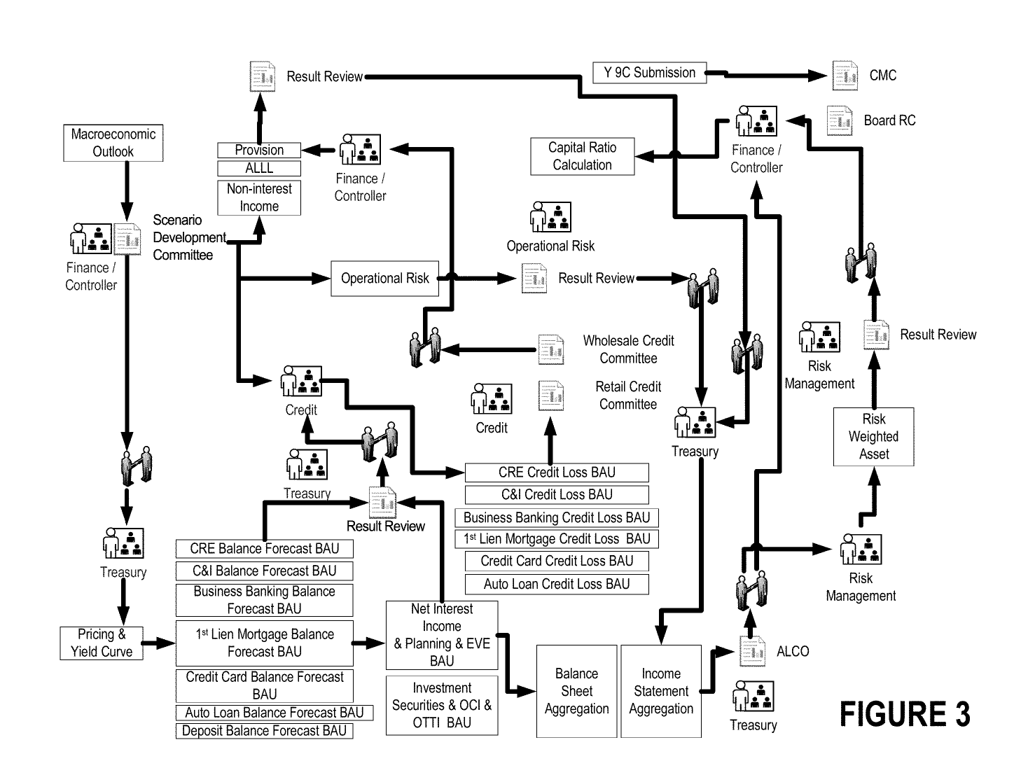

FIG. 3 demonstrates how, under the new rules, a financial institution may employ pre-regulation model(s) in addition to more risk management practitioners working alongside each department. In short, FIG. 3 illustrates an example of an inefficient compliance framework that has been employed by many financial institutions over the last decade. The primary reason for these additional hires is to ensure regulatory compliance, which is largely independent from day-to-day business operations.

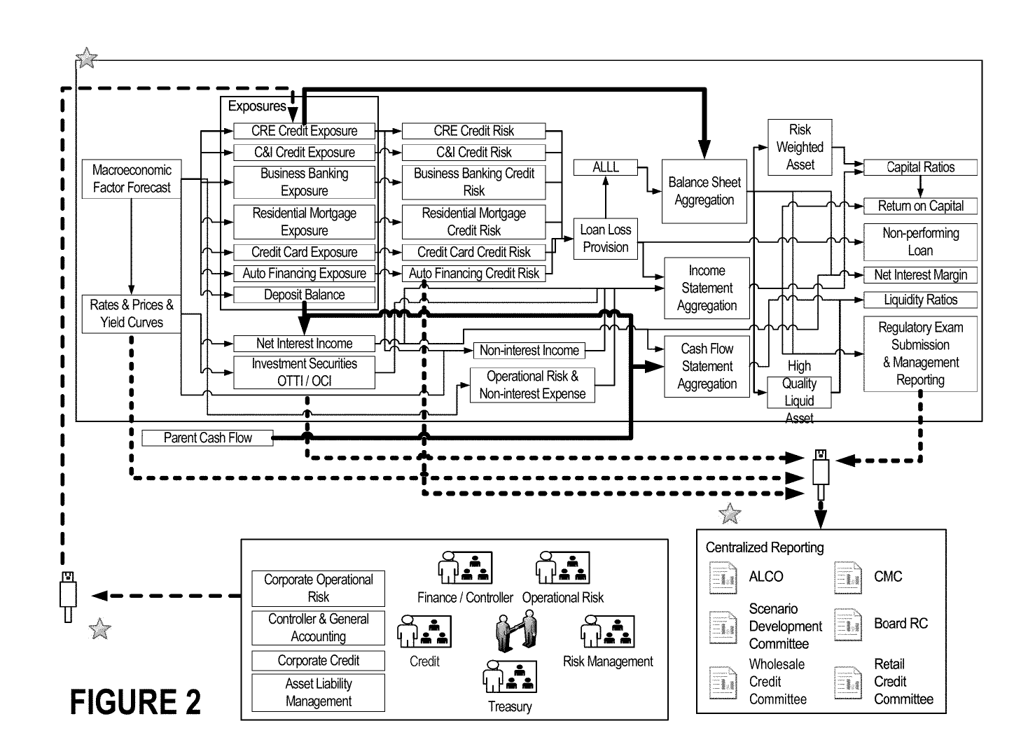

FIG. 2, meanwhile, includes a flow chart illustrating an optimized technique in which a compliance framework is simultaneously employed by a financial institution alongside the day-to-day operational planning. As further described below, a risk management platform may be responsible for employing the compliance framework. To employ the compliance framework, the risk management platform can implement a smart connect designed to work with nearly all preexisting process across the various departments of a financial institution. The “universal plug” technology can provide inter-department collaboration capabilities and timely risk assessments, while eliminating the need for a complete redesign because:

1. The technology largely avoids the operational risk in implementing a new system that is large and/or invasive;

2. The technology reduces the difficulty of educating practitioners about a new system by producing recommendations developed via machine learning; and

3. The technology considerably reduces the cost to deploy a new system.

### Data Analysis, Risk Management, and Automated Compliance Framework

### I. Smart Connector

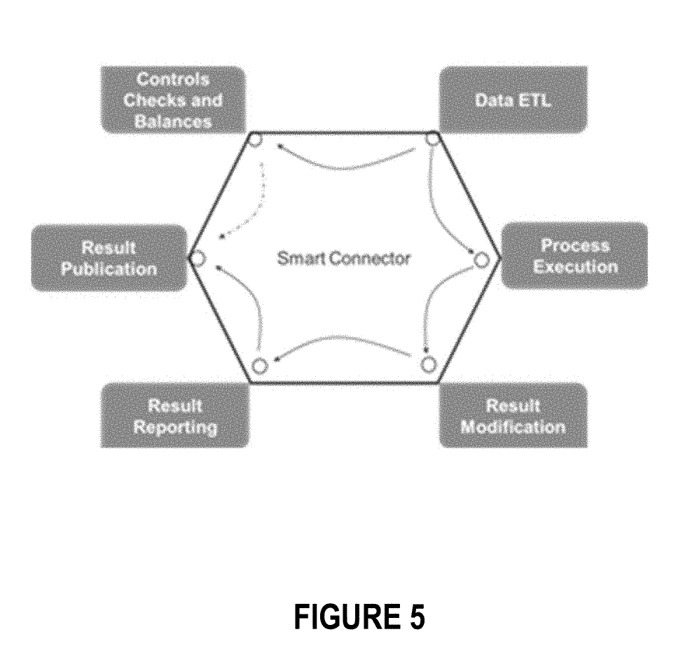

The design of the technology described herein (also referred to as a “smart connector” or “universal plug”) began with an in-depth analysis of what a risk management operation will normally entail in response to the new regulatory requirements. As shown in FIG. 5, critical risk management operations generally share six tasks in common across the various departments of a financial institution. These six tasks are described in greater depth below.

### 1. Performing Controls, Checks, and Balances of Data

A sound risk analysis process will generally first ensure that the data to be used for analytics can be associated with an official source. These data may include the date, number of accounts, activities of accounts, features of accounts, history of accounts, related products and individuals associated with accounts, hierarchies of accounts, etc. Metadata specifying the version(s) of data, source(s) of data, provider(s) of data, or format(s) of data may also be verified and/or recorded.

Historically, it has been challenging for practitioners to manually perform this task in a timely and precise matter, as this task requires that the practitioners possess complete knowledge of the entire data landscape. However, in most financial institutions nowadays, the amount of data has become intractable. By employing a smart connector, a risk management platform can detect requests for information (e.g., submitted by a practitioner working for a given financial institution) and then recommend the appropriate data for each request based on intrinsic information that lies in the given financial institution's data repository. Moreover, the smart connector may be able to facilitate the automatic generation of audit logs for all records/actions involved in the risk analysis process. Thus, the smart connector may intelligently monitor the activities performed by the practitioner(s) over the course of the risk analysis process.

### 2. Performing Data Extraction, Transformation, and Loading (“ETL”) Operations for Downstream Analytical Processes

Almost all practitioners will inevitably deal with multiple sources of information over the course of a risk analysis process (or multiple risk analysis processes), as the financial institution will need to synthesize information about the economic market, regulatory rules, clients (e.g., entities and individuals to whom the financial institution lends money), department(s) of the financial institution, and their own legacy information. Due to the siloed nature of the financial institution's operating model, data will generally come in in a variety of forms despite decades of pushing for data centralization/homogenization. For instance, data may come in the form of Microsoft Excel® worksheets, databases, flat files, and structures produced by third-party software such as SAS®, MATLAB®, R, or Python®.

Financial institutions will often have drastically different preferences for formatting/storing data, and there is no dominant, common, or industry standard practice. Practitioners have historically spent more than half of the time performing ETL operations on data before performing risk analysis processes. One way to reduce the time spent performing ETL operations is to build adaptors for common data forms, such as those mentioned above. The smart connector described herein can provide application programming interfaces (“APIs”) that connect to these various data repositories, services, structures, etc. Accordingly, a risk management platform may implement a smart connector to ensure that data handled during a risk analysis process can be readily examined, regardless of how many sources are responsible for providing the data. The smart connector may also support a recommendation engine that informs users of the risk management platform of the best and/or most commonly-used repositories and ETL operations.

### 3. Executing Analytical Operations or Analytical Platforms

Risk analysis processes are compulsory tasks that may be similar to ETL operations in the sense that there is no dominant, common, or industry standard practice. Accordingly, financial institutions across the industry have adopted a wide variety of analytical integrated development environments (“IDEs”) and analytical platforms (e.g., SAS®, R, Python®, MATLAB®, C++, C#, Java®, Quantitative Risk Management (QRM), Bancware®, Bloomberg®, Wind Information) to facilitate the completion of risk analysis processes. Executing programmed models (or simply “models”), especially those that require sequential execution of operations in different analytical platforms, represents another potential bottleneck in process interconnection and automation. Moreover, the number of options in analytical IDEs creates an intractable problem for practitioners because:

i. It is impossible for a given practitioner to be proficient in all analytical IDEs; and

ii. It is impossible for a given practitioner to accurately know which process(es) within a financial institution have been altered, modified, or developed.

One way to handle this issue (and also reduce execution latency) is to build adaptors for common analytical platforms, such as those mentioned above. The smart connector described herein can provide APIs that connect to these various analytical platforms. By implementing a smart connector, a risk management platform may be able to seamlessly interface with these common analytical platforms, thereby eliminating one of the most painful aspects of redesigning the risk analysis process. In addition, the smart connector may be able to inform users of the risk management platform which operation(s)/IDE(s) have been used most often for a given task, which operation/IDE is best suited for the given task, which operation(s)/IDE(s) can be used to facilitate completion of the given task, etc.

### 4. Modifying Analytical Results to Account for Managerial Overlay or Discretion

Responsible practitioners will often alter the results of an analytical operation based on immediate facts, managerial discretions, and/or known limitations of the analytical operation. Modifications are generally based on each financial institution's unique business situation, and modifications can be made for a single event, a single client (e.g., an entity to whom the financial institution has lent money), a group of accounts, a specific industry, a specific geographical location, a specific product, a specific segment of products sharing feature(s) in common, etc. To facilitate the entry of these modifications, the smart connector may create/support modification channel(s), as well as an easy-to-operate graphical user interface (“EOGUI”) that can guide users in performing the appropriate type(s) of modification operations. In practice, the EOGUI may be embodied as a simplified interface that overlays management discretions on single-event analysis, cohort adjustments, top-of-the-house adjustments, etc.

### 5. Compiling Reports to Meet Regulatory and Managerial Requirements

Financial institutions continue to rely heavily on traditional means (e.g., Microsoft PowerPoint® presentations and Microsoft Excel® graphs) for presenting analytical results to decisionmakers. Manual labor-based compilation of Microsoft PowerPoint presentations, however, creates bottlenecks in the real-time delivery of the results of a risk analysis process. In the meantime, some divisions of financial institutions have already begun using business intelligence software (also referred to as “business intelligence tools”), such as Tableau®, Power BI®, and QlikView®, to generate interactive dashboards. However, most financial institutions are still far from systematic, enterprise-wide adoption of business intelligence tools.

By creating seamless API connections between an analytical engine (also referred to as an “analytics module”) employed by the risk management platform and various resources (e.g., traditional computer programs and/or newer business intelligence tools), the smart connector can operate as a universal connection. Thus, the smart connector can facilitate the interconnection between different resources to increase the likelihood of adoption of these resources by financial institutions. Moreover, the smart connector may recommend the most popular (or most appropriate) reporting templates based on historical usage. The recommended reporting templates may be used by various risk management departments across the financial institution. As further described below, at least some of the fields within these reporting templates may be automatically populated without human intervention. For example, the smart connector may employ machine learning algorithm(s) to discover the type and/or format of content suitable for each field within a given reporting template and then populate these fields accordingly. Thus, the smart connector may allow the risk management platform to offer a reporting functionality that automates the creation and/or combination of off-the-shelf, static, or interactive reports produced using various reporting tools.

### 6. Sending Analytical Results to Downstream Operation(s)

The landscape of result-sharing techniques also varies, with traditional means such as Microsoft Excel spreadsheets, comma-separated values (“CSV”) files, emails, and relational databases and emerging means such as alternative data repositories and web publications. The incompatibility across these systems, as well as the need to toggle between these systems, usually slows throughput down significantly. To address this issue, the smart connect may support a publication functionality that records and sends analytical results in mainstream data formats to downstream operation(s) or stakeholder(s), such as worksheets, databases (e.g., relational databases), flat files, emails, etc.

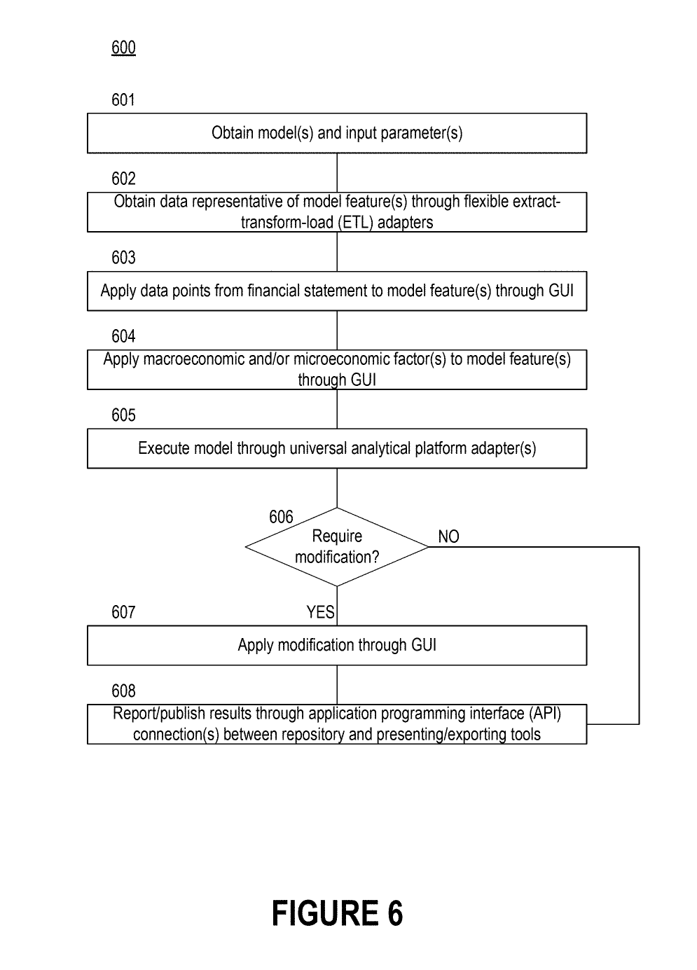

FIG. 6 depicts a flow diagram of a process 600 for performing risk analysis on behalf of a financial institution in accordance with embodiments of the technology. The flow diagram illustrates how a smart connector, when executed by a risk management platform, can process data to complete a risk analysis assessment. One key to the process 600 is the ability to create an ensemble of connections to various publication media, so that a delay-free connection can be establish between an upstream operation (also referred to as a “publishing process” or “transmitting process”) and a downstream operation (also referred to as a “receiving process”) regardless of media.

Initially, the risk management platform can obtain a set of models and input parameters (step 601). Generally, the user will upload the model(s) and/or input parameter(s) directly to the risk management platform through a graphical user interface (or simply “interface”). However, in some embodiments, the risk management platform may be configured to examine data repositories associated with the financial institution to discover the model(s) and/or input parameter(s) without user input. The user may be, for example, a practitioner who works for the financial institution (e.g., in the risk management group) or works on behalf of the financial institution. Each model may be in the form of a script written in SAS, R, Python, MATLAB, or some other common programming language used to create programmed models.

Next, the risk management platform can obtain data representative of model features through flexible extract-transform-load (ETL) adapters employed by the smart connector (step 602). Examples of model features include time-varying predictive information, economic forecasting scenarios, and other high-level configurations. The ETL adapters may interface with various data sources, such as Microsoft Excel spreadsheets, databases (e.g., tabular data structures), and network-accessible storage (also referred to as “cloud storage”), to acquire information. The information may be related to loans, securities, credit ratings, geographical locations, industries, and/or other features related to the model(s) obtained by the risk management platform. In some embodiments, flexible ETL adapters are automatically generated by the smart connector through supervised machine learning exercises using scripts corresponding existing models and their metadata. For example, if models with a given feature set (e.g., Feature Set A) use data from certain sources (e.g., Table T1 joined by Table 2), the same flexible ETL adapter may be assigned to a newly-obtained model with the given feature set. A feature set could specify the model category, script language, script input parameters, user(s) that frequently execute these models, or any combination thereof.

Thereafter, the smart connector can obtain data points from a financial statement associated with the financial institution and then apply these data points to the model features as inputs through the interface (step 603). In some embodiments the user is prompted to upload the financial statement (or a summary of the information included in the financial statement) through the interface, while in other embodiments the risk management platform examines data repositories associated with the financial institution to discover the financial statement without user input. Macroeconomic and/or microeconomic factor(s) may also be applied to the model features through the interface (step 604). Such factors can include unemployment rate, gross domestic product (“GDP”) growth rate, industry forecast, etc. For example, the risk management platform may parse the financial statement(s) of a financial institution to discover its holdings in high-risk categories, cashflow, and cash on hand, and then apply these pieces of information to an economic forecasting model to predict the financial state of the financial institution in one or more economic scenarios.

The model script can then be executed using the analytical platform adapter(s) deemed necessary by the risk management platform based on the programming language of the model script and/or the hardware environment (step 605). Results can initially be saved to a persistent storage medium. Following execution of the model script, the risk management platform may allow the user to decide whether to perform operation(s) to modify the results (step 606). For example, the user may determine whether to modify the output(s) produced by the model script based on factors such as industry, segment, location, market condition, etc. In some embodiments, the risk management platform may automatically determine whether to perform predefined modification operation(s). For example, the risk management platform may determine that the output(s) produced by the model script should be modified if a predetermined percentage of other users have applied modification operation(s). These other users may include practitioners working for the same financial institution as the user, practitioners working for a different financial institution than the user, or any combination thereof.

If the user opts to modify the results, the output(s) produced by the model script can be modified through the interface in accordance with the modification operation(s) (step 607), and then the modified results can be reported, published, or made accessible through an API (step 608). In some embodiments the modification operation(s) are predefined (e.g., by the user or the risk management platform), while in other embodiments the modification operation(s) are dynamically created by the user while completing the risk analysis process. Conversely, if the user opts not to modify the results, then the unmodified results can simply be reported, published, or made accessible through the API (step 608). As further described below, the results (whether modified or unmodified) are generally presented by a business intelligence tool using a pre-created reporting template. Additionally or alternatively, the results can be shared using a desired publication medium, such as digital files, emails, database tables, web publishing, etc.

### II. Smart Connector Repository Management

Smart connectors can be developed for different commercial entities (e.g., Financial Institution A, Financial Institution B, Financial Institution C), different types of commercial entities (e.g., financial institutions, insurance providers, and pharmaceutical manufacturers), different sources, etc. Introduced here, therefore, is a repository management tool that can create, configure, modify, and manage smart connectors, as well as execute concatenated networks of multiple smart connectors. In some instances, an entity may employ a network of multiple smart connectors as part of a comprehensive risk analysis system. For example, a risk management platform may employ a first smart connector to interface with a first data source, a second smart connector to interface with a second data source, a third smart connector to interface with a first business intelligence tool, etc.

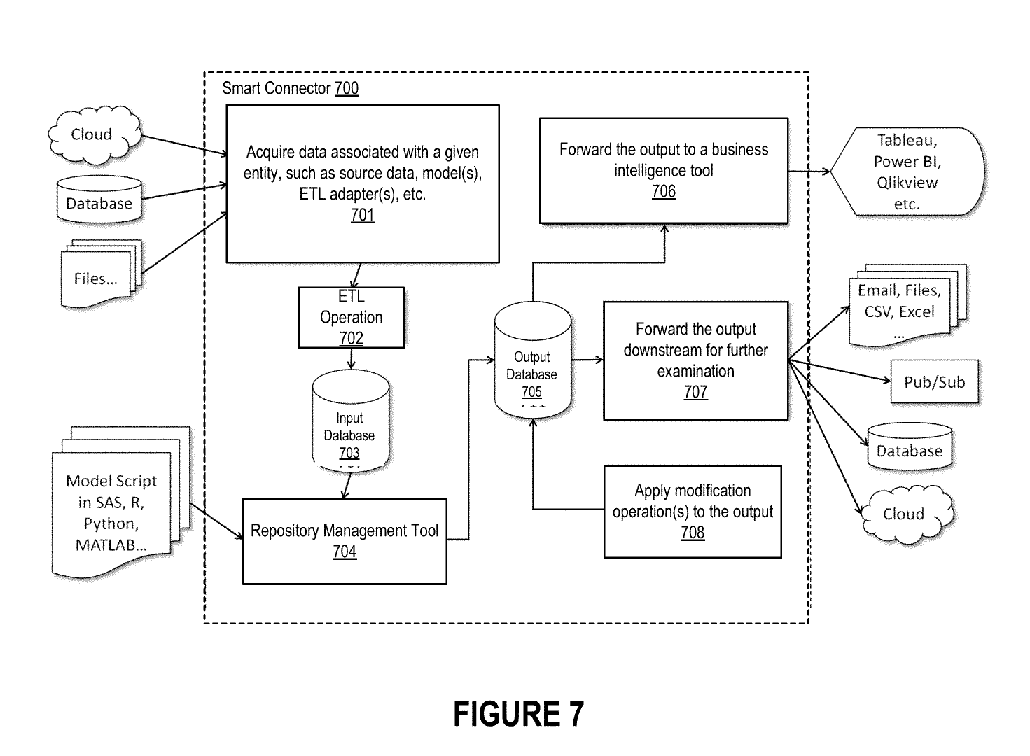

FIG. 7 includes a generalized illustration of a smart connector 700 that is responsible for acquiring, examining, and processing data in accordance with various embodiments of the technology. While FIG. 7 illustrates how a smart connector could be implemented in some embodiments, those skilled in the art will recognize that smart connectors could be implemented in other ways. For example, another smart connector may be designed to interface with different sources of information, execute model scripts written in different programming languages, etc.

Initially, the smart connector 700 can acquire data associated with a given entity from cloud storage(s), public databases, private databases, etc. (step 701). The data may come in the form of Microsoft Excel® worksheets, databases, flat files, or structures produced by third-party software such as SAS®, MATLAB®, R, or Python®. By performing an ETL operation (step 702), the smart connector can obtain metadata from the data to perform the process(es) necessary to create an input database 703.

Similarly, the smart connector 700 may acquire model scripts written in SAS, R, Python, MATLAB, etc. These model scripts may be uploaded by a practitioner responsible for performing a risk analysis process on behalf of the given entity. In some embodiments, a repository management tool 704 examines, catalogues, or stores these model scripts in a library for subsequent use. For example, upon receiving input indicative of a selection of a given model script, the repository management tool 407 may acquire the appropriate data from the input database 703 and then provide the data to the given model script as input to produce an output. The output may be stored in an output database 705.

As shown in FIG. 7, outputs produced by model scripts can be handled in several different ways. In some embodiments, an output (or a portion thereof) is forwarded to a business intelligence tool (e.g., via an API) for presentation to a user in a business-friendly fashion (step 706). In some embodiments, the smart connector 700 forwards the output (or a portion thereof) downstream for further examination (step 707). The appropriate downstream process(es) may be based on metadata extracted from the output, the model script, or the output itself. In some embodiments, the smart connector 700 applies modification operation(s) to the output (or a portion thereof) (step 708). For example, a modification operation may be applied to account for the impact an imminent default on a large commercial real estate (“CRE”) loan will have on the given entity. As another example, a modification operation may be applied to account for a sudden increase in cashflow that has not been accounted for. After applying the modification rule(s), the smart connector 700 may perform step 706 or step 707. Accordingly, the smart connector 700 could forward a modified output or an unmodified output (also referred to as a “raw output” or “raw result”) to business intelligence tool(s), downstream process(es), downstream system(s), etc.

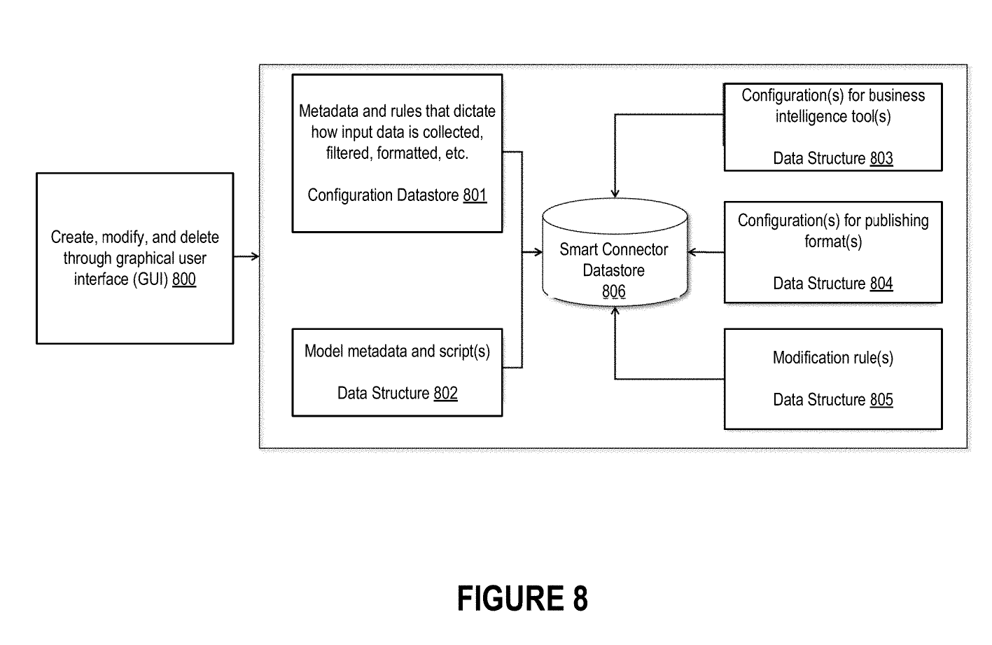

FIG. 8 includes a generalized illustration of a repository management tool designed to receive input via a graphical user interface (or simply “interface”) through which users can create, modify, and delete smart connectors and their accompanying information. Together, each smart connector and its accompanying information (e.g., metadata) may be referred to as a “smart connector module.”

The interface 800 is typically comprised of three separate sections, each of which is designed to facilitate the creation, modification, or deletion of smart connector modules. A configuration datastore 801 can retain metadata and rules that dictate how the data to be provided as input for models should be collected, filtered, formatted, etc. Such action may make the data more readily consumable by subsequent processes. The metadata can include:
1. Data type metadata for database, files, cloud storage, and/or other types of datastore;
2. Resource paths for the datastore(s), including predefined connectors for major cloud storage providers; and
3. ETL operations that regulate the format of data that resides in the input database (e.g., input database 703 of FIG. 7).

The repository management tool can maintain a first data structure 802 that includes metadata for each model. The metadata may specify, for example, the name, creation date, script language, model theory, and/or other characteristic(s) that are required by the risk management platform to execute the corresponding model. In addition to the metadata, the first data structure 802 may contain user-friendly labels that specify the appropriate scenario(s) for each model. The repository management tool may support interface(s) that enable a user to add, modify, or delete these user-friendly labels.

The repository management tool can also maintain a second data structure 803 that maps business process(es) to business intelligence tool(s). A risk management platform may use these relationships to determine where the output produced by a model should be routed. For example, the risk management platform may discover, by examining the second data structure 803, that outputs produced by a first model should be forwarded to a first business intelligence tool, outputs produced by a second model should be forwarded to a second business intelligence tool and a third intelligence tool, etc.

In some embodiments, the repository management tool also maintains a third data structure 804 that maps business process(es) to another aspect of the reporting process, such as the publishing format and publishing method. Examples of publishing formats include flat file, database table, and Microsoft Excel spreadsheet, while examples of publishing methods include email, local repository, cloud storage, direct publication (e.g., to the Internet), or queuing. For example, the risk management platform may discover, by examining the third data structure 804, that outputs produced by a first model should be delivered to a local repository in the form of flat files, while outputs produced by a second module should be delivered to a user as a Microsoft Excel spreadsheet included in an email.

Further yet, the repository management tool may maintain a fourth data structure 805 that includes the modification rule(s) that can be applied to outputs produced by models after the outputs have been stored in an output database (e.g., output database 705 of FIG. 7). For example, the risk management platform may discover, by examining the fourth data structure 805, that the outputs produced by models associated with a given entity should be subjected to a particular set of modification rules.

The information residing within the configuration datastore 801 and these other data structures 802, 803, 804, 805 is stored within a smart connector datastore 806. Thus, in some embodiments, the smart connector datastore 806 may include all information needed to facilitate the risk analysis process.

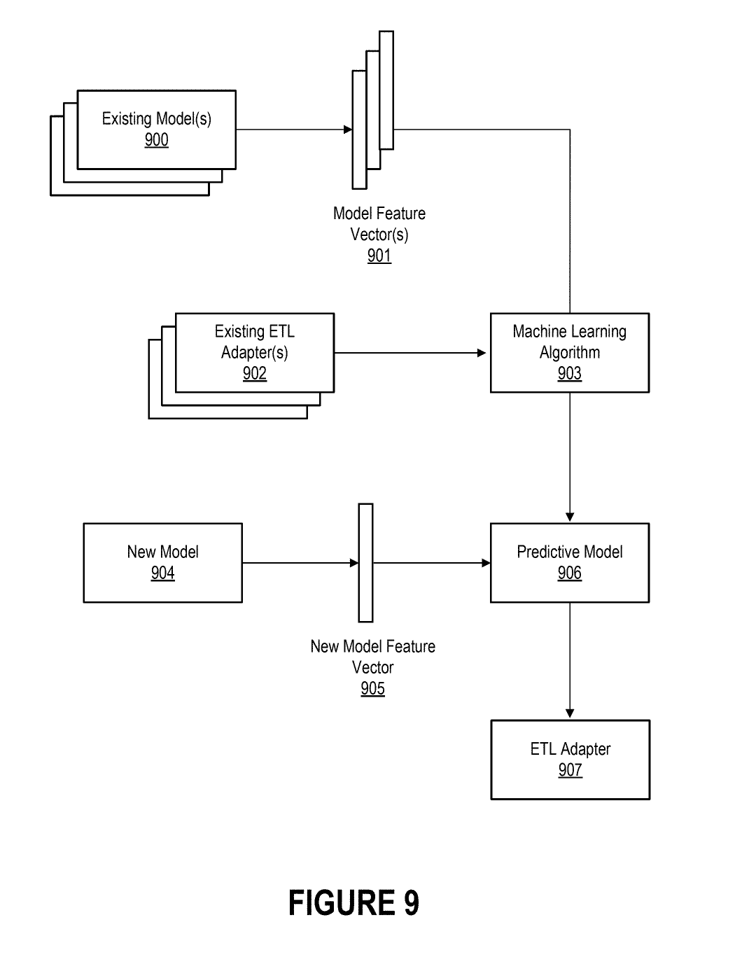

FIG. 9 illustrates how a supervised machine learning technique can be used to train a predictive model to create an ETL adapter for a new model. Such a technique may be performed after a user has uploaded the new model to the risk management platform via an interface (e.g., in advance of performing a risk analysis process using the new model). Generally, an ETL adapter will define how to transform the data acquired from a given source (also referred to as “source data”) into a format that can be consumed by a given model.

Initially, a risk management platform can identify one or more existing models 900 that can be applied to data acquired by a smart connector. The risk management platform can then examine the existing model(s) 900 to extract a feature vector from each existing model, thereby producing one or more feature vectors 901. A feature vector may include features such as model category, script language, script input parameter(s), characteristic(s) of users that employ the corresponding model, etc.

Thereafter, the risk management platform can generate a predictive model 906 by applying a machine learning algorithm 903 that considers the feature vector(s) 901 and at least one existing ETL adapter 902 as input. The machine learning algorithm 903 may be a gradient descent algorithm designed to product the predictive model 906. To produce a new ETL adapter 907 for a new model 804, the risk management platform can identify the new model 904, extract a new feature vector 905 from the new model 904, and then provide the new feature vector 905 as input for the predictive model 906, which can produce the new ETL adapter 907 as output. Such a process allows the risk management platform to produce a new ETL adapter 907 that is tailored for the new model 904.

### III. Risk Management Platform

As noted above, some entities are obligated to complete risk analysis processes on a periodic (e.g., quarterly or yearly) basis. However, several factors have begun to make compliance increasingly difficult. Introduced here, therefore, are risk management platforms able to implement an automated framework designed to manage, parse, and analyze data for purposes of facilitating compliance with relevant policies in a distributed computer environment. By implementing the technology described herein, an entity (e.g., involved in healthcare, pharmaceuticals, finance, gaming, etc.) can ensure that it complies with the latest regulatory policies, recognizes emerging risks, and conducts more efficient operational planning.

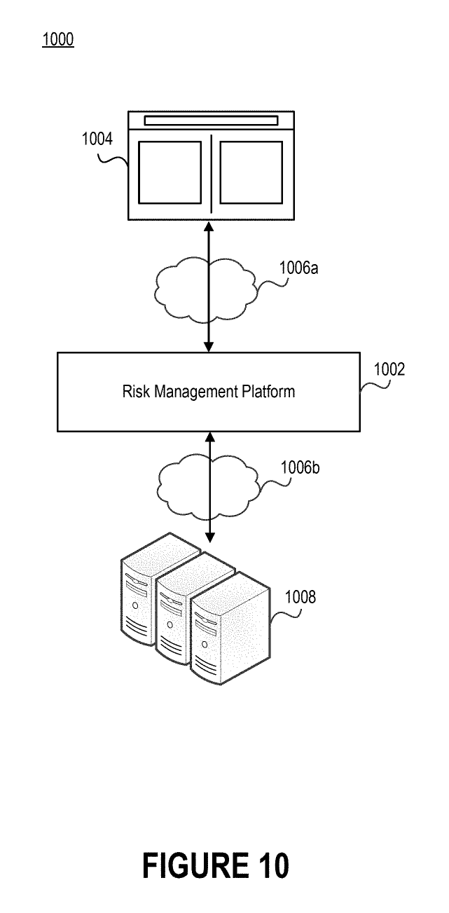

FIG. 10 illustrates a network environment 1000 that includes a risk management platform 1002. Users can interface with the risk management platform 1002 via an interface 1004. The risk management platform 1002 may be responsible for developing and/or applying models to data associated with a given entity. For example, in the case of a financial institution, the risk management platform 1002 can generate warnings to inform the financial institution about the impacts of principle risk factors on its investments. The risk management platform 1002 also enables the financial institution to assess its risk positions under various macroeconomic, microeconomic, or entity-specific situations in real time. For example, a user of the risk management platform 1002 may be able to assess the impact of a slowing in the multi-family real estate market on the financial institution's capital adequacy, non-performing loan level, interest margin, liquidity position, and return on capital. Such knowledge may enable the financial institution to preemptively take the appropriate action(s) to address identified vulnerabilities.

In some embodiments the user can choose from amongst multiple predefined economic scenarios, while in other embodiments the user is able to create a plausible economic scenario by specifying economy-related characteristic(s). For example, upon receiving data from a source, the risk management platform 1002 can apply natural language processing algorithm(s) to automatically read structured, semi-structured, or unstructured data. Examples of sources include cloud storage(s), public databases, private databases, flat files, etc. The risk management platform 1002 may use this data to generate an economic scenario for risk and compliance purposes. The risk management platform 1002 may also be responsible for creating the graphical user interfaces through which users can view entity information (e.g., name, location, holdings, cashflow), model information (e.g., the corresponding economic parameters), review reports produced by models, manage preferences, etc.

As shown in FIG. 10, the risk management platform 1002 may reside in a network environment 1000. Thus, the risk management platform 1002 may be connected to one or more networks 1006a-b. The network(s) 1006a-b can include personal area networks (PANs), local area networks (LANs), wide area networks (WANs), metropolitan area networks (MANs), cellular networks, the Internet, etc. Additionally or alternatively, the risk management platform 1002 can be communicatively coupled to computing device(s) over a short-range communication protocol, such as Bluetooth® or Near Field Communication (NFC).

The interface 1004 is preferably accessible via a web browser, desktop application, mobile application, or over-the-top (OTT) application. Accordingly, the interface 1004 may be viewed on a personal computer, tablet computer, mobile workstation, personal digital assistant (PDA), mobile phone, game console, music player, wearable electronic device (e.g., a watch or fitness accessory), network-connected (“smart”) electronic device, (e.g., a television or home assistant device), virtual/augmented reality system (e.g., a head-mounted display), or some other electronic device.

Some embodiments of the risk management platform 1002 are hosted locally. That is, the risk management platform 1002 may reside on the computing device used to access the interface 1004. For example, the risk management platform 1002 may be embodied as a mobile application executing on a mobile phone or a desktop application executing on a laptop computer. Other embodiments of the risk management platform 1002 are executed by a cloud computing service operated by Amazon Web Services® (AWS), Google Cloud Platform™, Microsoft Azure®, or a similar technology. In such embodiments, the risk management platform 1002 may reside on a host computer server that is communicatively coupled to one or more content computer servers 1008. The content computer server(s) 1008 can include data associated with various entities, models, historical outputs produced by the models (or analyses of the historical outputs), and other assets. Such information could also be stored on the host computer server.

Certain embodiments are described in the context of network-accessible interfaces. However, those skilled in the art will recognize that the interfaces need not necessarily be accessible via a network. For example, a computing device may be configured to execute a self-contained computer program that does not require network access. Instead, the self-contained computer program may cause necessary assets (e.g., data, models, and processing operations) to be downloaded at a single point in time or on a periodic basis (e.g., weekly, daily, or hourly). Such a design may be desirable if the user wants results of the risk management process to remain confidential.

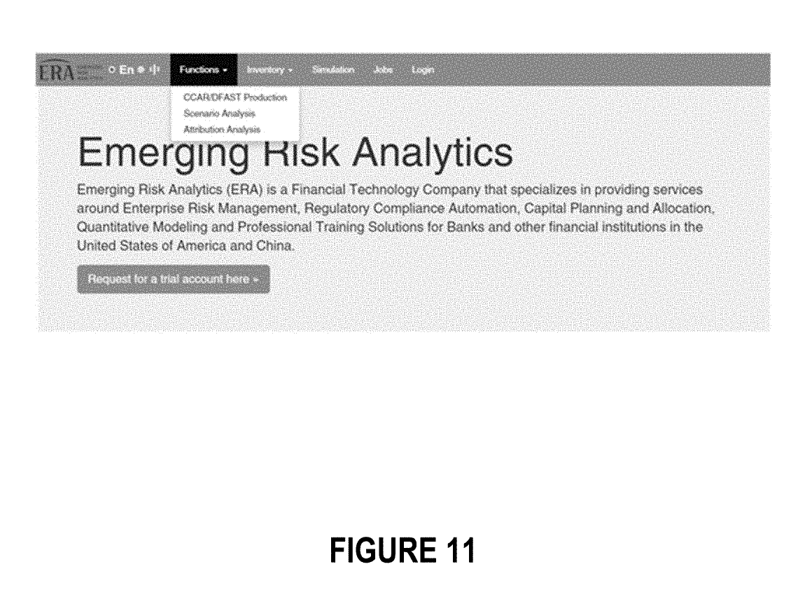

Generally, the risk management platform includes three functional modules: (1) a module for performing comprehensive capital analysis and reviews (CCARs) and Dodd-Frank Act Stress Tests (DFASTs); (2) a module for analyzing various economic scenarios; and (3) a module for analyzing model attribution. FIG. 11 includes an example of a graphical user interface (or simply “interface”) that, when accessed by a user, allows the user to choose from amongst these functional modules. In order to utilize these functional modules, the user may be prompted to enter credentials (e.g., a username and password) by the risk management platform.

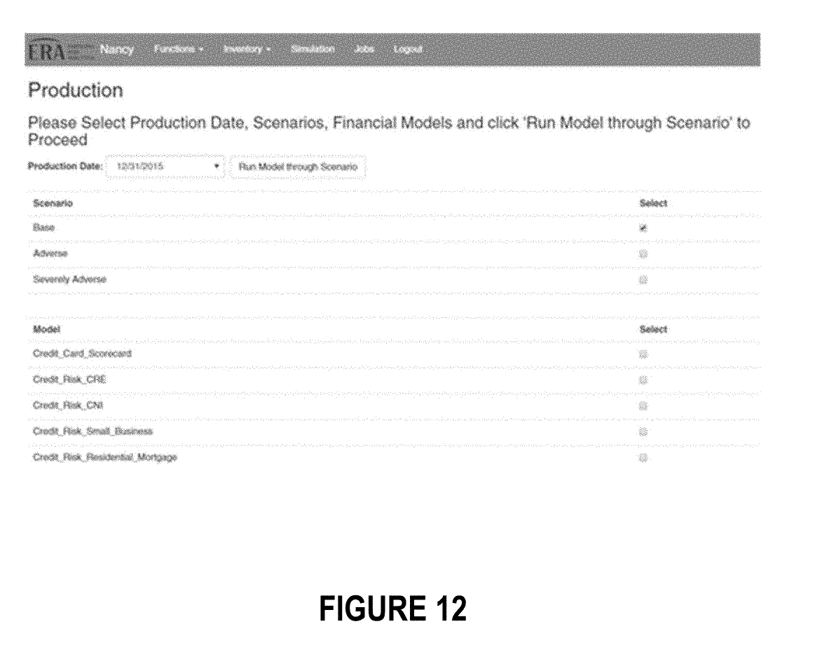

FIG. 12 includes an example of an interface that may appear when the user selects the “CCAR/DFAST Production” entry under the “Functions” tab on the interface of FIG. 11. This interface may allow the user to select/provide values for different parameters used in stress testing. These parameters include:
1. Production Date: This value represents the date at which the stress test should begin.
2. Scenario: The economic scenario and the macroeconomic situation of the financial institution can be specified by the user. The economic scenario (also referred to as the “external market scenario”) could be set to “base,” “adverse,” or “severely adverse” when performing a stress test. These entries represent different scenarios for the economy as a whole. The risk management platform may be configured to estimate the financial state of an entity in a single scenario or multiple scenarios (e.g., each economic scenario described above).
3. Model: The user can specify which model(s) should be employed as part of a risk analysis process. These models may correspond to different product lines, business lines, etc. The user may be permitted to select a single model or multiple models.

After adjusting these parameters, the user can select the graphical element labeled “Run Model Through Scenario” to initiate the stress test.

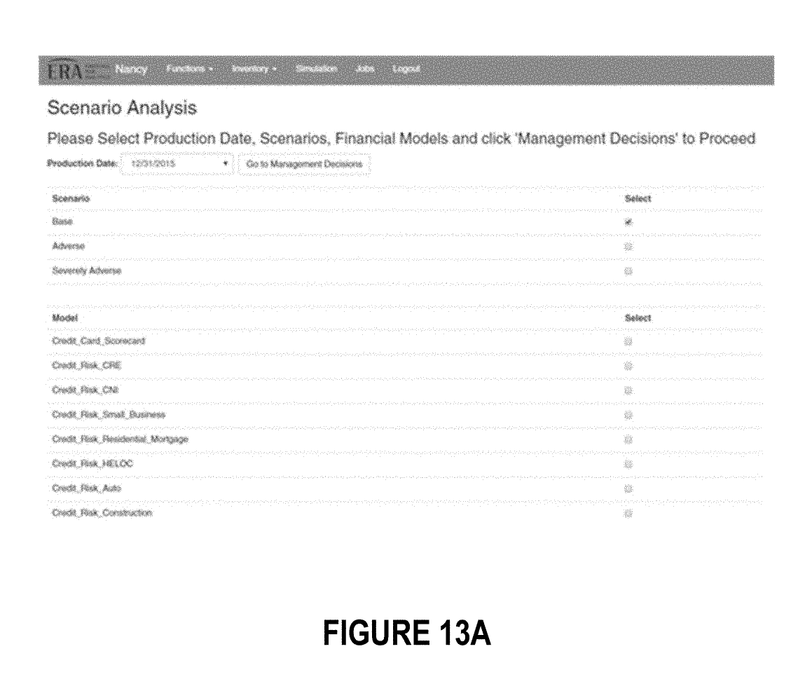

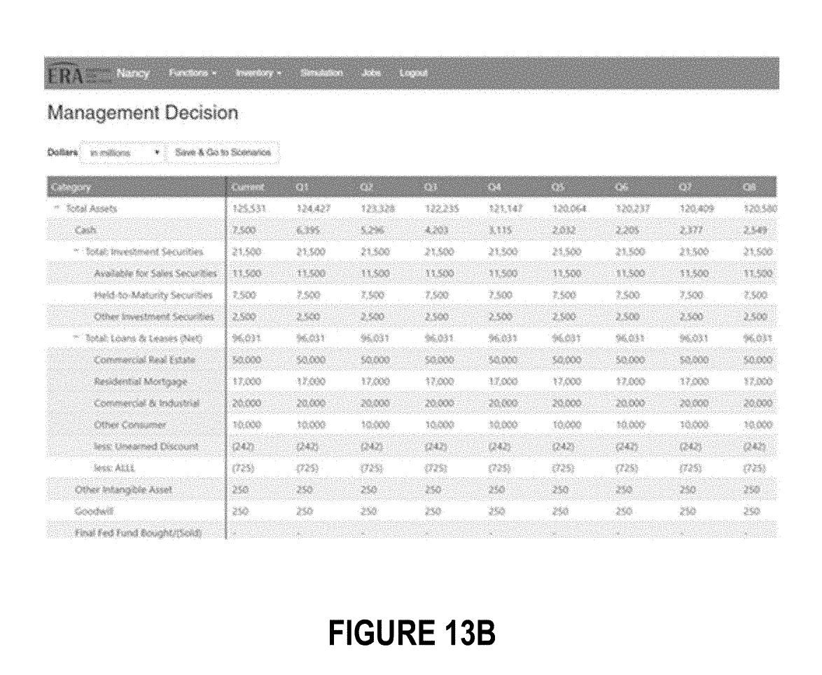

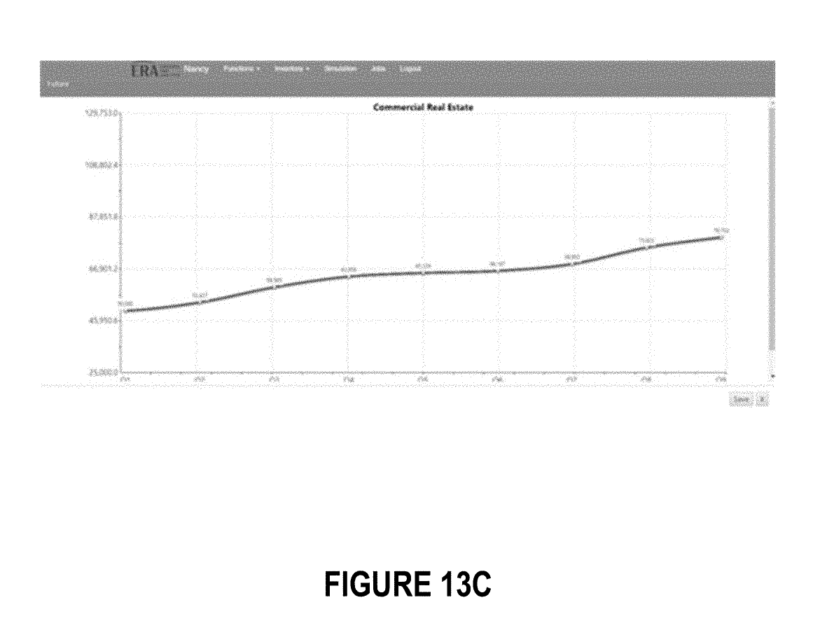

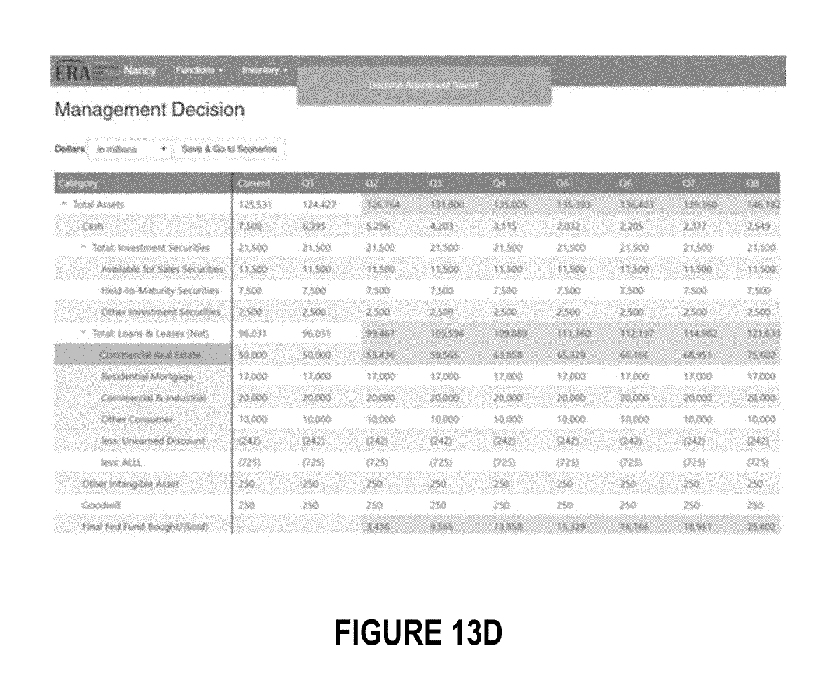

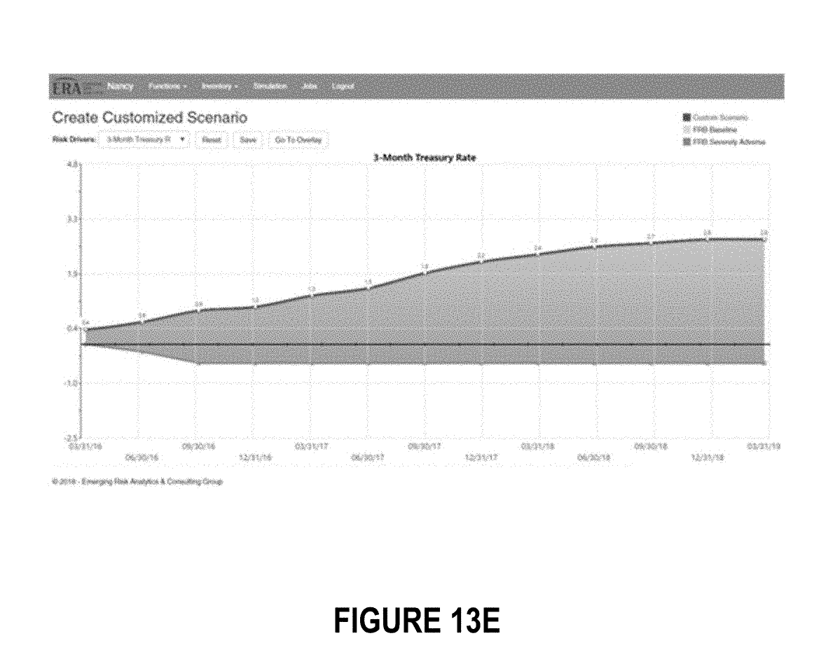

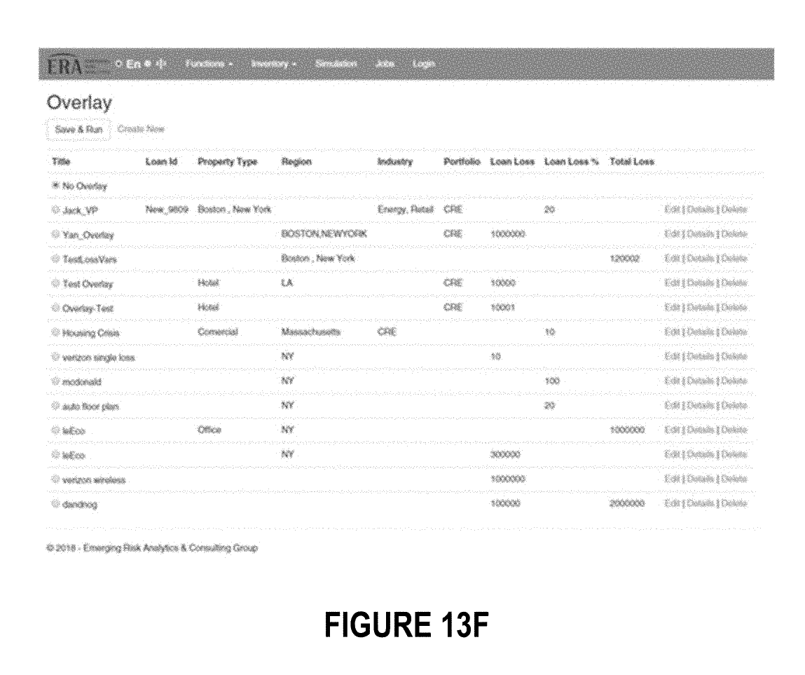

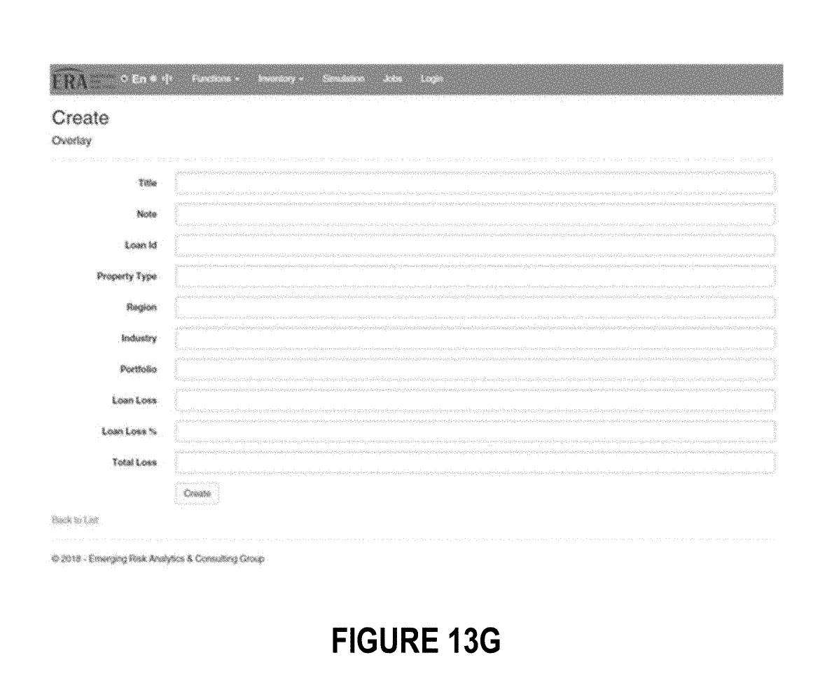

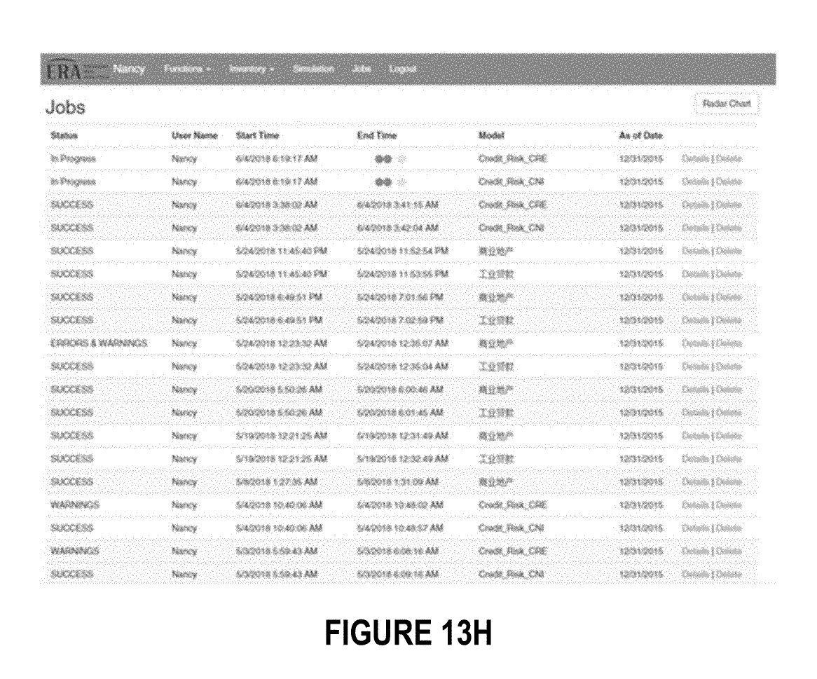

FIG. 13A includes an example of an interface that may appear when the user selects the “Scenario Analysis” entry under the “Functions” tab on the interface of FIG. 11. Much like the interface shown in FIG. 12, this interface may allow the user to select/provide values for different parameters used in scenario analysis. These parameters include:
1. Production Date: This value represents the date at which the scenario analysis should begin.
2. Scenario: The economic scenario and the macroeconomic situation of the financial institution can be specified by the user. The economic scenario (also referred to as the “external market scenario”) could be set to “base,” “adverse,” or “severely adverse” when performing scenario analysis. These entries represent several different economic outcomes for the external market as a whole. These entries represent different scenarios for the economy as a whole. The risk management platform may be configured to estimate the risk status of an entity in a single scenario or multiple scenarios (e.g., each economic scenario described above).
3. Model: The user can specify which model(s) should be employed as part of a risk analysis process. These models may correspond to different product lines, business lines, etc. The user may be permitted to select a single model or multiple models.

After adjusting these parameters, the user can select the graphical element labeled “Go to Management Decisions.” Upon receiving input indicative of a selection of the graphical element, the risk management platform may generate an interface that includes the balance sheet of the financial institution, as shown in FIG. 13B. In some embodiments the balance sheet will have been uploaded by the user, while in other embodiments the balance sheet will have been automatically retrieved from a data repository on behalf of the user. The user may be permitted to select certain entries in the balance sheet. For example, as shown in FIG. 13B, the risk management platform may visually distinguish those entries that can be modified. When the user selects one of these entries, the risk management platform may allow the user can adjust the value in the selected entry (e.g., by altering the number in the corresponding field). For example, the user may opt to alter the total value of CRE loans in future quarters. As another example, the user may opt to draw out credit for a selected asset type into future quarters. Rather than require the user alter the source data, the risk management platform allows the user to alter these values while performing risk analysis.

FIG. 13C includes an example of an interface through which the user can alter the fiscal strategy of the financial institution for a given product line, business line, or industry by varying value(s) in the balance sheet. Here, the risk management platform has depicted the fiscal strategy as a line graph, though other visual means may be used in other embodiments (e.g., bar charts or tables). The user can alter the fiscal strategy by dragging the line toward the desired value or clicking the desired value (in which case the line may move automatically). For example, if the user expects the financial institution to decrease its future CRE holdings, the user could select lower values for future quarters (e.g., 45,000 for Q4, 40,000 for Q5, 35,000 for Q6, etc.). In such embodiments, the risk management platform may automatically fit the line to the value(s) specified by the user.

After making the desired changes, if any, the risk management platform can automatically balance the balance sheet of the financial institution on behalf of the user. In some embodiments, the risk management platform may identify the entries affected by such action. In FIG. 13D, for example, the risk management platform has highlighted those entries that were modified during the balancing process. The user may be permitted to freely modify these entries. For example, the user could alter the entries for a single business account or multiple business accounts. Any changes specified by the user could then be automatically implemented throughout the remainder of the balance sheet. For example, if the user specifies that the financial institution is expected to increase its commercial loans involving a given entity in future quarters, then the risk management platform may update each entry in the row labeled “Commercial & Industrial” under “Total: Loans & Leases (Net).”

To proceed, the user can select the graphical element labeled “Save & Go to Scenarios.” Upon receiving input indicative of a selection of the graphical element, the risk management platform may generate an interface that allows the user to alter various aspects of the economic scenario, as shown in FIG. 13E. Through this interface, the user may be able to adjust the economic scenario by defining the macroeconomic, mesoeconomic, or microeconomic risk factors in a single market or multiple markets. The user can alter various factors that will influence the economic scenario. Examples of factors include the three-month treasury rate, gross domestic product (GDP), disposable income, mortgage rate, exchange rate, consumer price index (CPI), tariff rate, bond credit rating, the London Inter-Bank Offered Rate (LIBOR), etc. Generally, these factors can be varied independently of one another. The initial baseline for each factor may come from a source representative of an economic forecast produced by, for example, Moody's Analytics, Standard & Poor's, the Federal Reserve System, or an in-house economist. Accordingly, the user may alter certain factor(s) to account for personal knowledge, market trends, etc.

The user can then select the graphical element labeled “Go to Overlay.” Upon receiving input indicative of a selection of the graphical element, the risk management platform may generate an interface that allows the user to make management-level adjustments to results produced by the scenario analysis, as shown in FIG. 13F. Thus, the user can make management-level adjustments before the output(s) produced by the model(s) have been optimized, published, etc. These management-level adjustments may account for unexpected events, special scenarios, and the deficiencies in the existing risk analysis process of the financial institution. Examples of such events include significant variations in trading relationships between entities/countries, reforms in the tax code that result in changes to the tax-related expenses of financial institutions, changes in monetary policy (e.g., of the Federal Reserve System), decisions of corporations (e.g., multinational corporations) having an impact on tax-, corporate-, or property-related expenses, etc.

The risk management platform may show historical decisions to the user in conjunction with the interface of FIG. 13F. Therefore, the user may be aware of past decisions regarding management-level adjustments. For example, the information available within a private source accessible to a financial institution may indicative that a given lendee's loss may exceed a baseline economic forecast. In some embodiments, the user may opt to create a new entry representative of a new management adjustment. In such embodiments, the user may select the graphical element labeled “Create New,” and the risk management platform may generate the interface shown in FIG. 13G. Through this interface, the user can adjust individual loans. For example, the user may increase the loss percentage upon discovering that a lendee of the financial institution is suffering a cashflow problem that normally precipitates bankruptcy. As shown in FIG. 13G, the user may also be able to adjust the group lender, region, industry, and portfolio via the corresponding fields of the interface. These adjustments of a loan may change the results of the scenario analysis in the form of an addend or a multiplier. Additionally or alternatively, the user may opt to modify an existing entry representative of an existing management adjustment. When the user chooses to edit the existing entry, an interface similar to the one shown in FIG. 13G may be shown, though the fields will have already been populated. The user can edit the existing entry by modifying at least one field and then saving the modification(s).

After making the necessary management adjustments, the user can select the graphical element labeled “Create” to save the information entered into the fields. The risk management platform can then present the interface of FIG. 13F once again. If the user is satisfied with the parameters of the scenario analysis, then the user can select the graphical element labeled “Save & Run.”

The risk management platform can then run the scenario analysis. FIG. 13H includes an example of an interface that includes a log of scenario analyses completed by the user. As shown in FIG. 13H, the risk management platform can assign a status to each analysis (also referred to as a “job”) to be performed. Examines of statuses include: (1) “In Progress” for those jobs that are presently being executed; (2) “Success” for those jobs that have been completed without issue; (3) “Failure” for those jobs that could not be completed; and (4) “Warning” for those jobs that have been completed but experienced an issue. Generally, if a job has been assigned a status of “Failure” or “Warning,” then the risk management platform may advise the user not to use any platform-generated reports without thorough investigation. If the risk management platform completes a job without issue, however, the corresponding entry may be labeled as a “Success.” To view the results, the user can select the graphical element labeled “Radar Chart.” As further described below, the results can be presented in various ways. While these statuses have been described in the context of scenario analyses, those skilled in the art will recognize that other aspects of the risk analysis process may also be labeled with similar statuses.

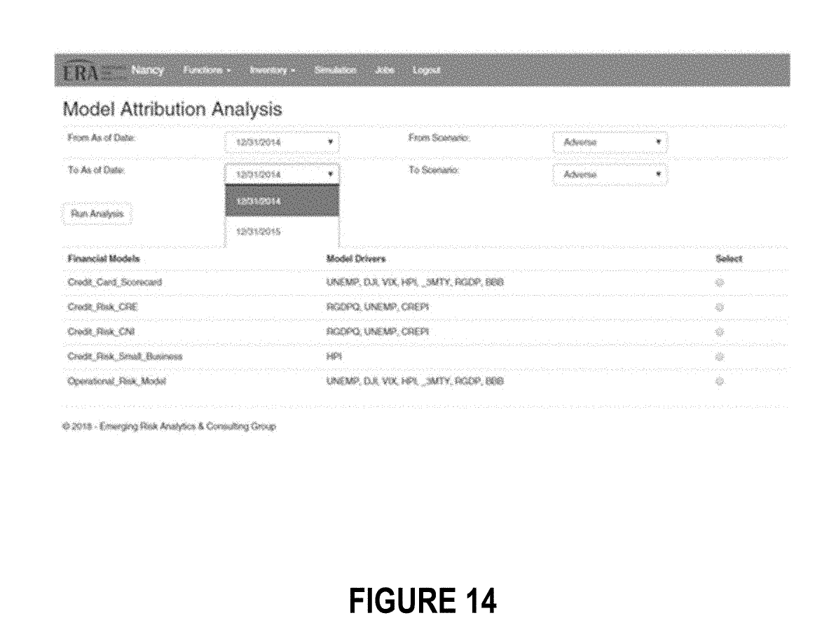

FIG. 14 includes an example of an interface that may appear when the user selects the “Attribution Analysis” entry under the “Functions” tab on the interface of FIG. 11. Much like the interfaces shown in FIGS. 12 and 13A, the interface may allow the user to select/provide values for different parameters used to perform attribution analysis. These parameters include:
1. Start Date: This value represents the date at which the attribution analysis should begin.
2. End Date: This value represents the date at which the attribution analysis should end.
3. Starting Scenario: This value specifies the economic scenario with which the attribution analysis should begin.
4. Ending Scenario: This value specifies the economic scenario with which the attribution analysis should end.
5. Financial Model Parameter(s): These value(s) specify different parameters of the model to be employed as part of the attribution analysis.

After specifying these parameters, the user can select the graphical element labeled “Run Analysis.” Upon receiving input indicative of a selection of the graphical element, the risk management platform can perform the attribution analysis, as well as analyze the influence of each financial model parameter.

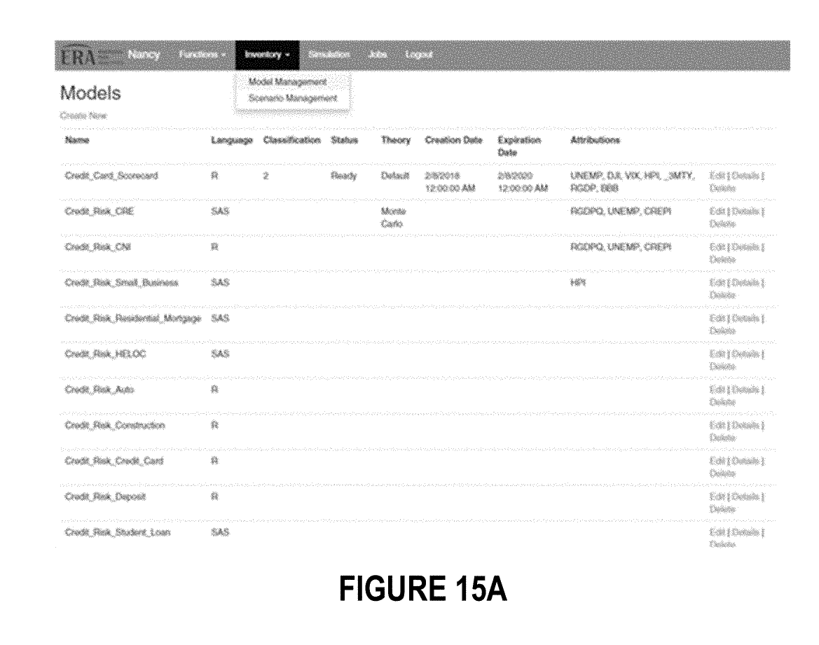

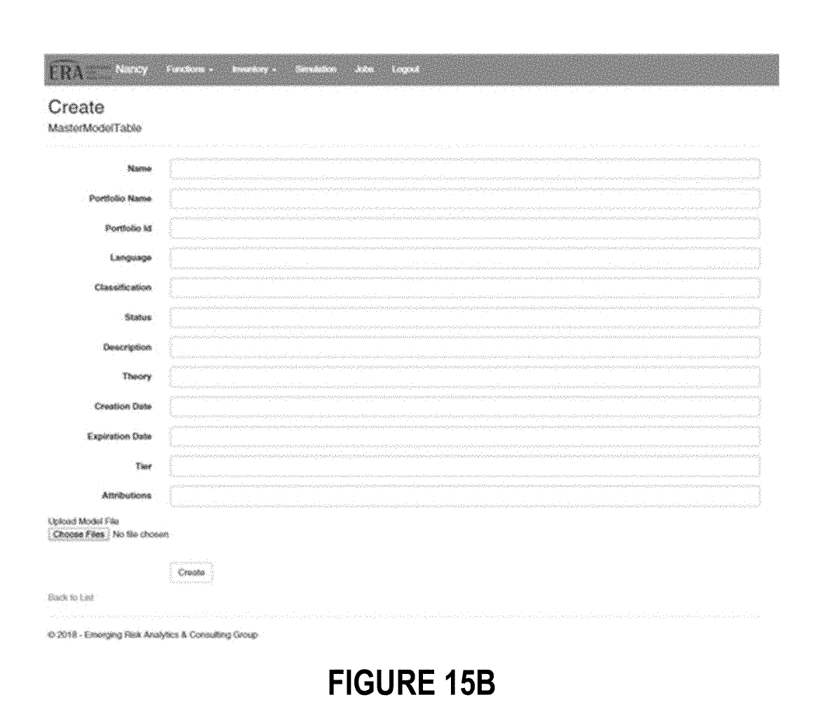

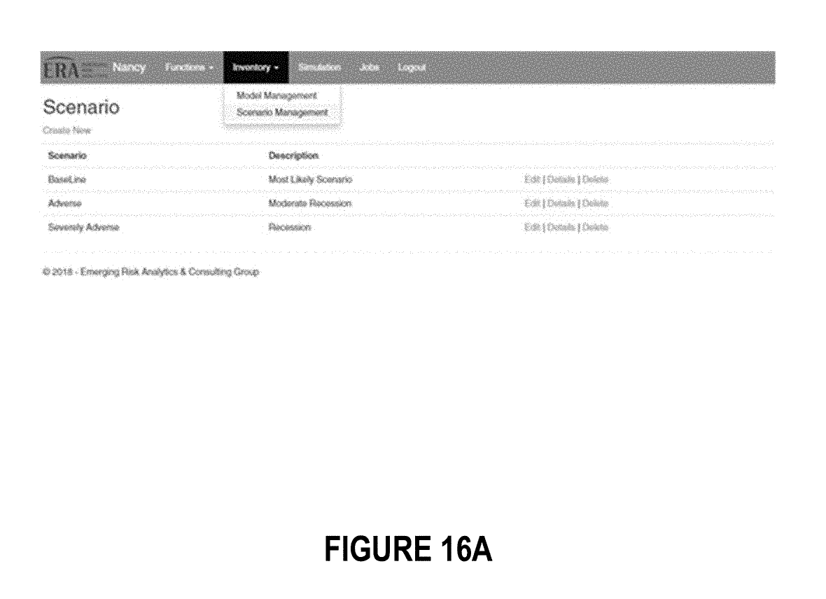

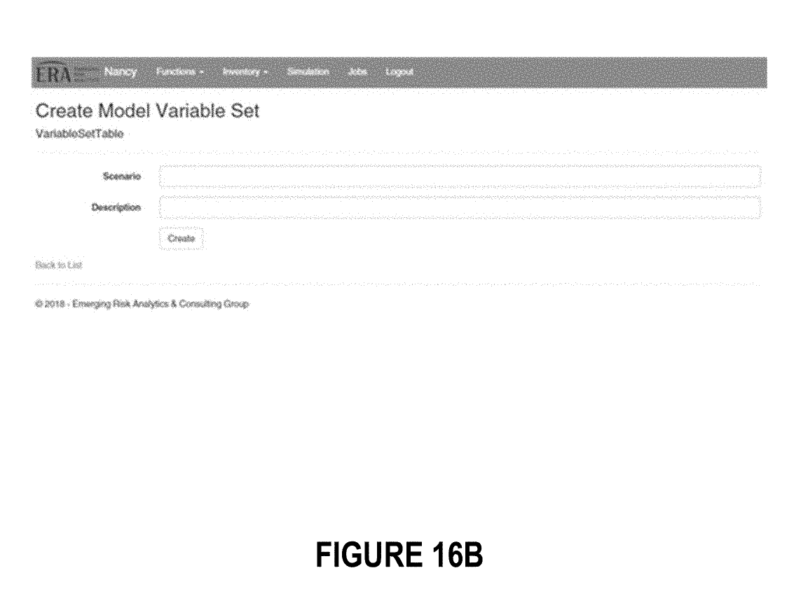

FIGS. 11-14 illustrate how a user can complete a risk analysis process using the risk management platform. More specifically, these interfaces illustrate how the user can readily define the parameter(s) of the risk analysis process to accomplish a task in minutes that has historically taken days or weeks. FIGS. 15A-16B, meanwhile, illustrate how a user can employ a risk management platform to add, delete, check, and/or modify different aspects of the risk analysis process.

In addition to the three functional modules described above, some embodiments of the risk management platform include two additional functional modules: (1) a module for managing models (also referred to as a “model management module”); and (2) a module for managing economic scenarios (also referred to as a “scenario management module”). FIGS. 15A-B include examples of interfaces that may be generated by the model management module, while FIGS. 16A-B include examples of interfaces that may be generated by the scenario management module.

FIG. 15A includes an example of an interface that may appear when the user selects the “Model Management” entry under the “Inventory” tab on the interface of FIG. 11. The interface may provide a list of all models that are available for simulating the future performance of a financial institution. The user may be permitted to edit, view, or delete these models. For example, the user may choose to edit a given model based on a change in the business strategy of the financial institution. As another example, the user may choose to delete a given model that is no longer necessary (e.g., because the model has been designed to simulate performance of CRE loans and the financial entity is no longer issues CRE loans).

To add a new model, the user can select the graphical element labeled “Create New.” Upon receiving input indicative of a selection of the graphical element, the risk management platform may generate an interface that prompts the user to enter the information needed to create the model, as shown in FIG. 15B. For example, the interface may include separate fields for model name, portfolio name (e.g., asset type or product line name), portfolio identifier, programming language (e.g., SAS, R, Python), model classification (e.g., specifying whether the model concerns credit risk, revenue, etc.), status (e.g., specifying whether the model has survived an expert review process), description, theory (e.g., discounted cash flow (“DCF”), Black Scholes, etc.), creation date, expiration date, tier/level (e.g., specifying how important the underlying analysis is to success of the financial institution), attributions or input parameters, etc. Then, the user can upload the model file by selecting the graphical element labeled “Choose Files.”

FIG. 16A includes an example of an interface that may appear when the user selects the “Scenario Management” entry under the “Inventory” tab on the interface of FIG. 11. Generally, each model will require that certain economic scenario parameters be specified (e.g., by the user or the risk management platform). The economic scenarios (also referred to as “external market conditions”) that are commonly used for risk analysis include an optimistic scenario, unfavorable scenario, and very unfavorable scenario. The interface shown in FIG. 16A allows the user to edit, delete, and modify aspects of these preset economic scenarios. For example, a financial institution might be a strategic partner of a technology company, and therefore might have deeper insights into business decisions made by the technology company. These insights may cause the financial institution to have a different view of an economic scenario than a generic, mainstream economic forecast. For instance, if the financial institution knows that the technology company wants to purchase property in a given location, the financial institution can increase the real-estate price forecast for the given location and/or decrease the real-estate price forecast for other locations.

To specify the conditions for a new economic scenario, the user can select the graphical element labeled “Create New.” Upon receiving input indicative of a selection of the graphical element, the risk management platform may generate an interface that allows the user to input the information needed to create a new economic scenario, as shown in FIG. 16B. Said another way, the risk management platform may permit the user to specify the parameters of the new economic scenario.

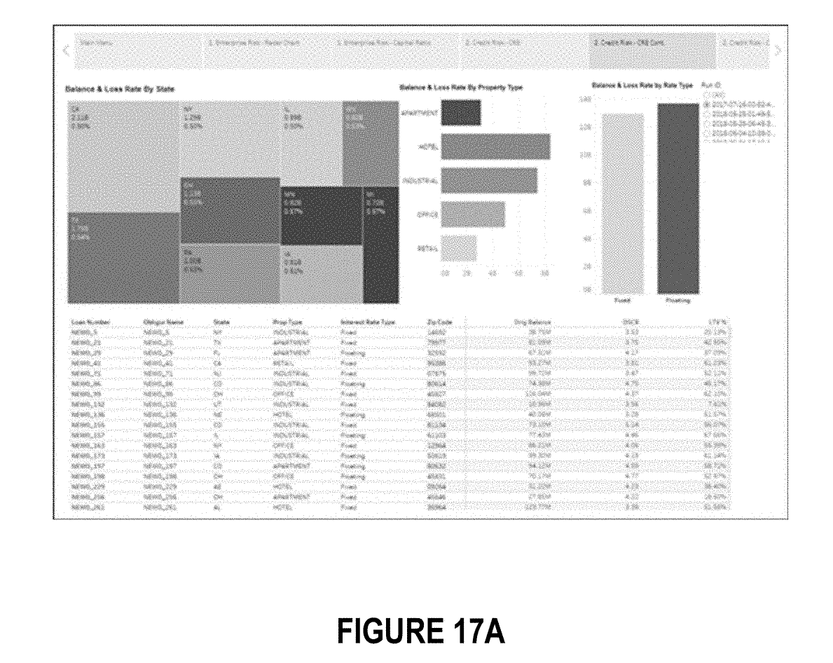

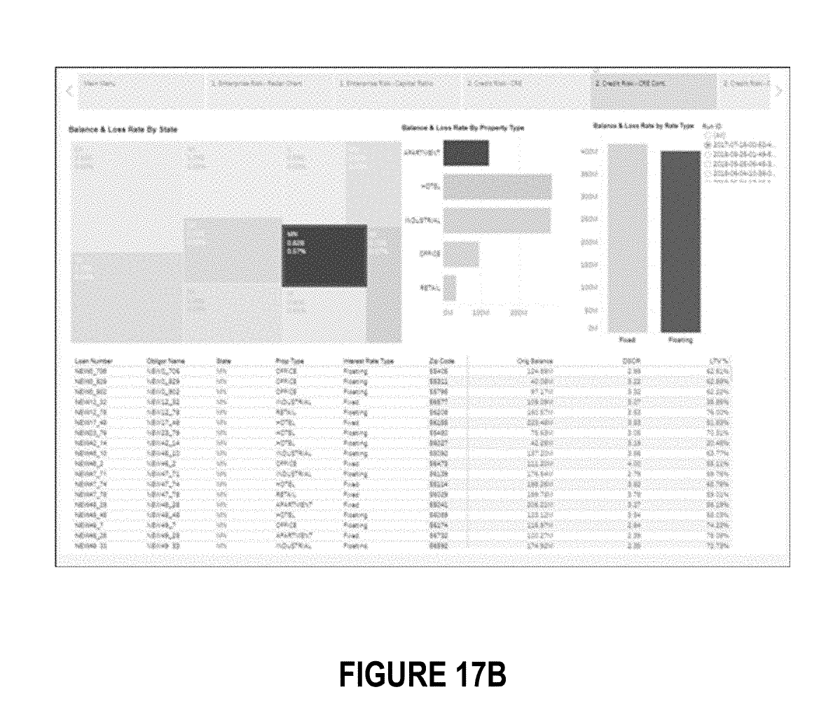

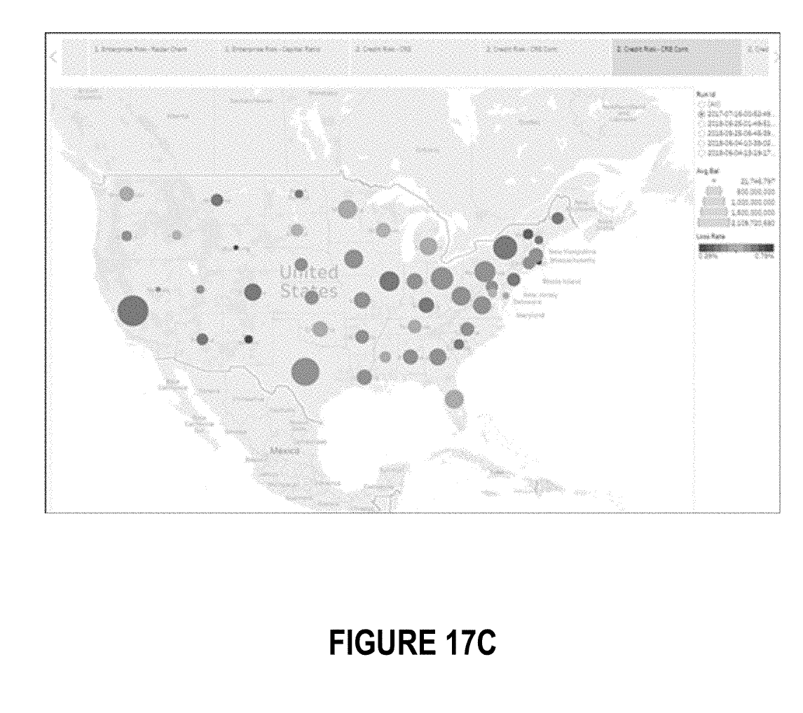

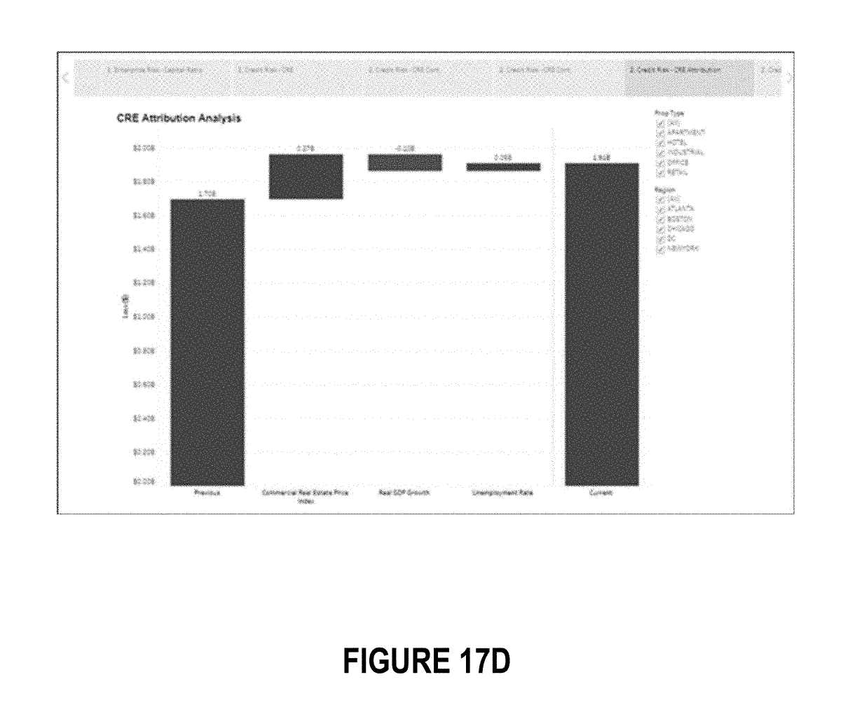

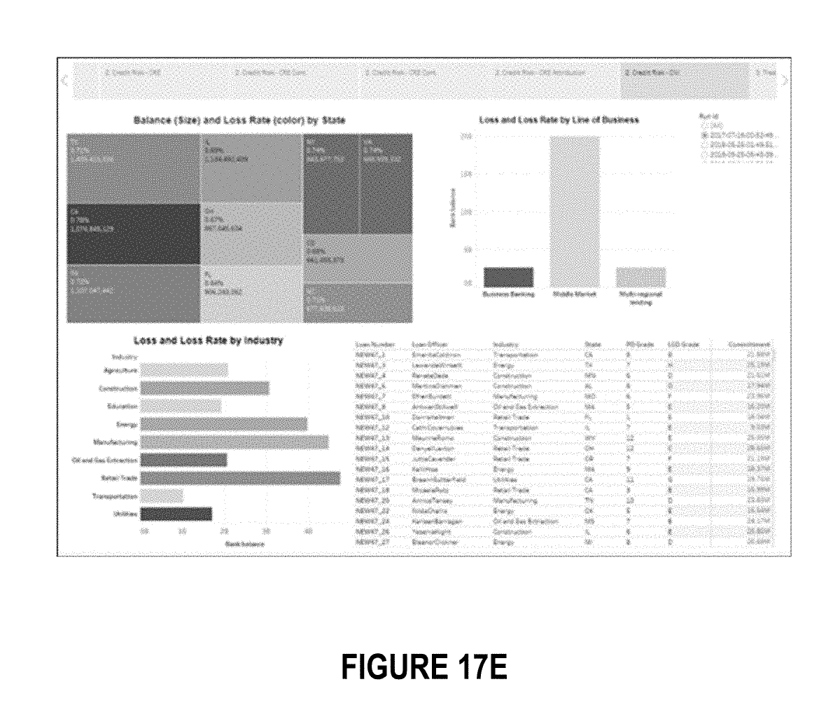

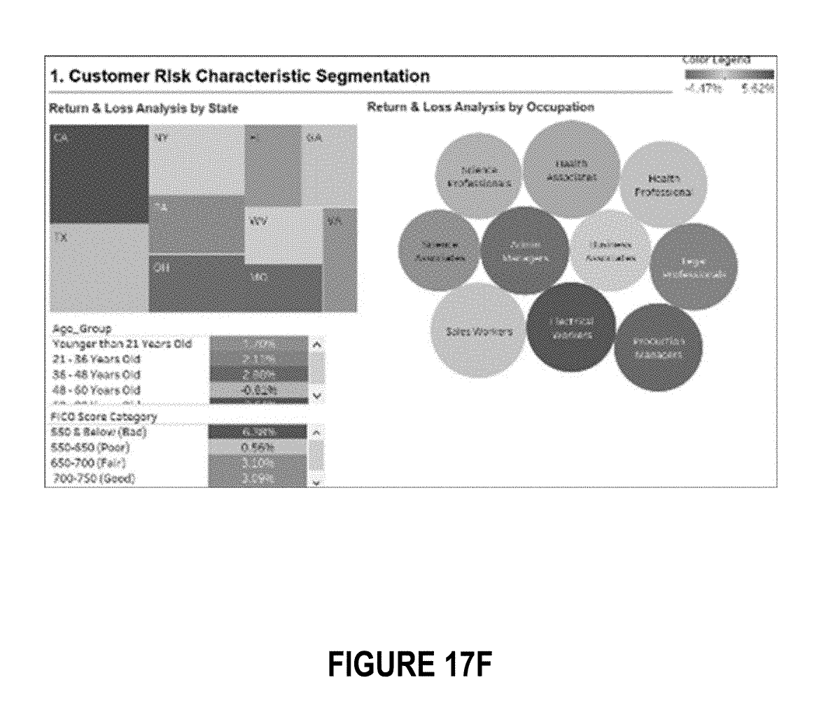

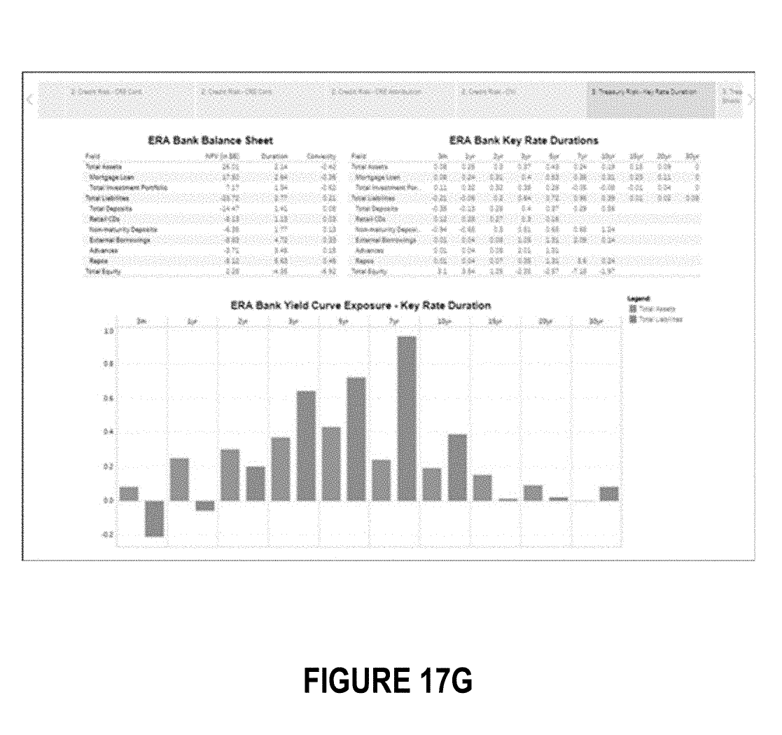

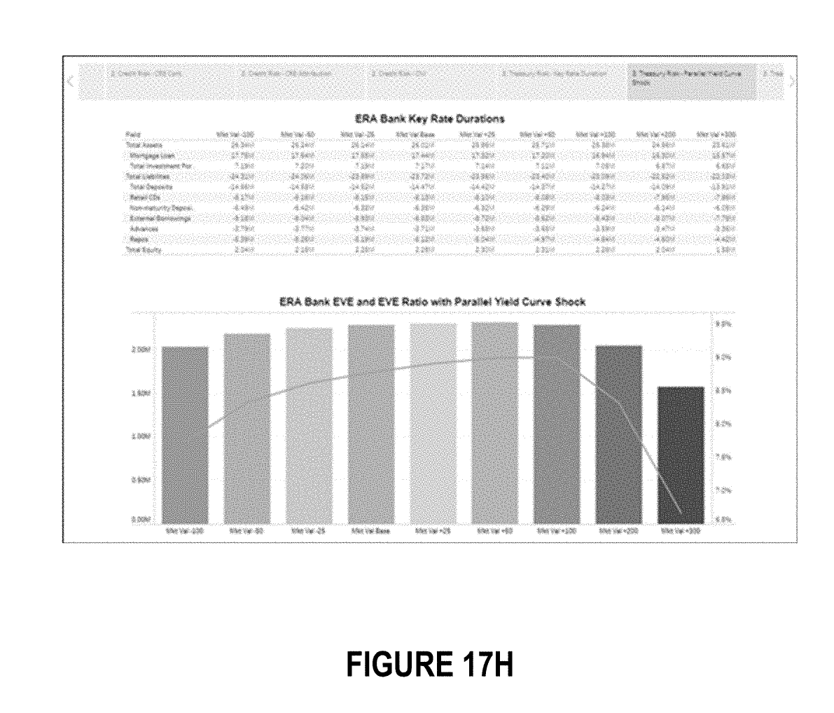

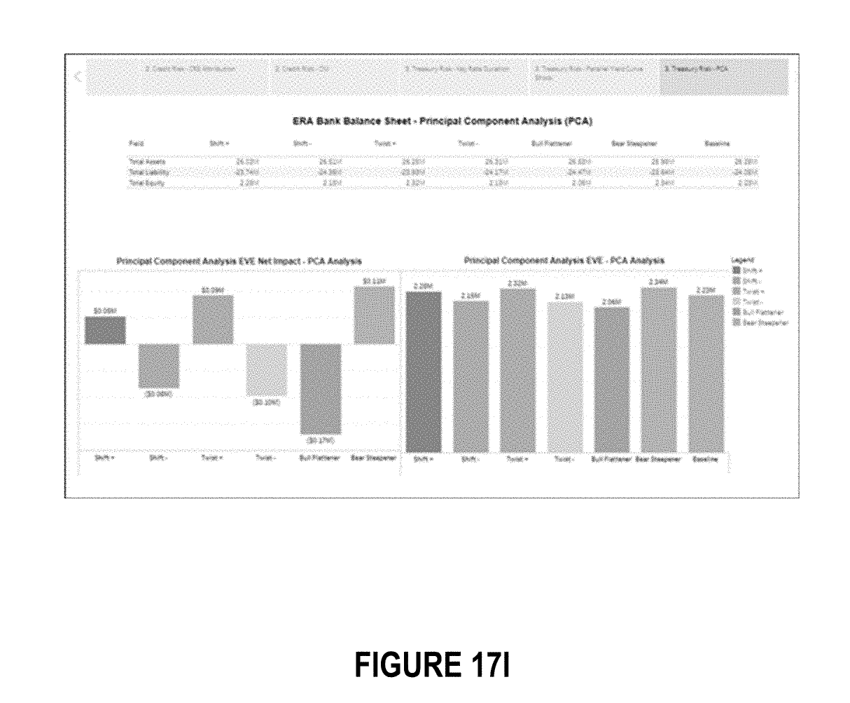

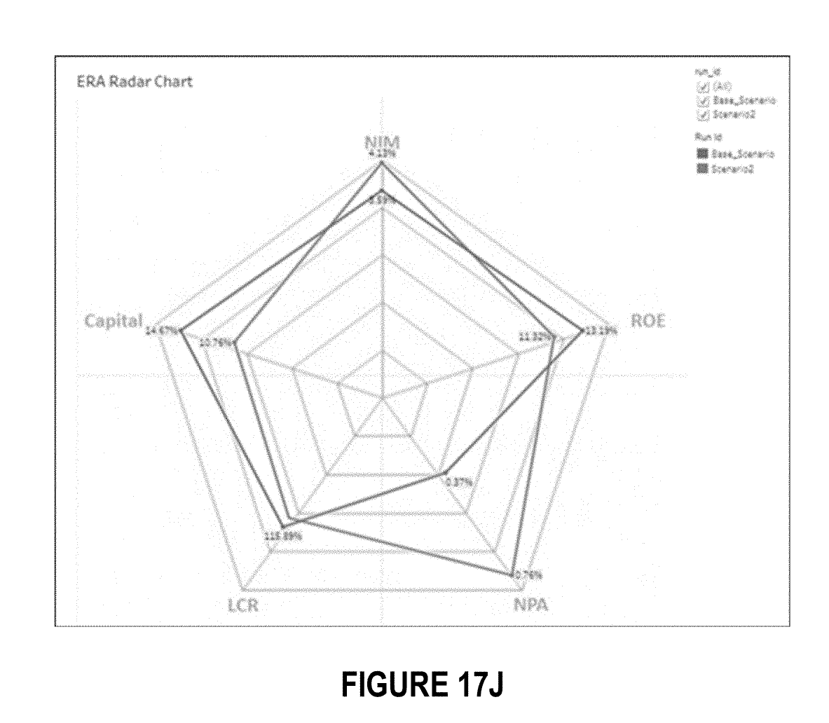

After the risk management platform has completed the risk analysis process, the risk management platform must display the results in a clear, meaningful way. In some embodiments, the risk management platform may cause interactive report(s) to be produced. For example, the user may be permitted to click on content (e.g., images and graphs), modify filters, etc. FIGS. 17A-J include examples of reports that may be produced by the risk management platform or a business intelligence tool that is communicatively connected to the risk management platform.

FIG. 17A includes an example of a report that shows lending balance and loss by location, property type, and enterprise. This report may be reviewed by the wholesale credit committee of a financial institution to gauge performance in each market segmentation, as well as what action(s), if any, need to be taken to lower economic risk. The example report shown in FIG. 17B is similar to the example report shown in FIG. 17A, but with a greater emphasis on a specific location (here, Minnesota).

FIG. 17C includes an example of a report that shows lending loss by location. This report may be reviewed by the management risk committee of a financial institution to establish the optimal allocation of funds across different geographies to minimize risk.

FIG. 17D includes an example of a report having an analysis of loss attribution. More specifically, the report shows what causes changes in loss by the financial institution from the last fiscal quarter to the current fiscal quarter. This report may be reviewed by the management risk committee of a financial institution to decide which source(s) of risk, if any, should be hedged.

FIG. 17E includes an example of a report showing lending balance and loss by location, industry, and enterprise. This report may be reviewed by the wholesale credit committee of a financial institution to establish performance in each market segment, as well as what action(s), if any, need to be taken to lower economic risk.

FIG. 17F includes an example of a report that shows lending balance and loss by location, customer age, credit score, occupation, etc. This report may be reviewed by the retail credit committee of a financial institution to establish performance in various market segments, as well as what action(s), if any, need to be taken to lower economic risk and increase income.

FIGS. 17 G-I include examples of reports that show healthiness of the balance sheet (e.g., in terms of cash flow, duration, convexity, liquidity coverage, economic value of equity, etc.) under different interest rate forecasts. These reports may be reviewed by the Asset and Liability Management Committee (ALCO) of a financial institution to decide whether the financial institution needs to buy/sell assets, raise funds, buy/sell derivatives, etc.

FIG. 17J includes an example of a report that may be reviewed by the Capital Management Committee (CMC) or C-suite of a financial institution to assess overall financial health. By examining the report, the CMC can establish what strategic decisions, if any, need to be made to improve performance.

In some embodiments, at least one of these reports is produced by the risk management platform in response to an explicit instruction to do so. For instance, the risk management platform may be configured to produce the report(s) upon receiving input indicative of a user interaction with a graphical element labeled, for example, “Complete Analysis” or “Create Report.” In other embodiments, at least one of these reports is automatically produced by the risk management platform upon certain condition(s) being met. For instance, the risk management platform may automatically update report(s) produced for a given user in response to determining that the given user altered a parameter of the risk analysis process (e.g., by changing the economic scenario, balance sheet, etc.).

### Risk Management Training

The risk management platform represents a sandbox environment in which the performance of an entity, such as a financial institution, can be simulated under different economic scenarios. To facilitate the performance of risk analysis processes, the risk management platform may maintain a library of past economic scenarios that can be used to train users. The users may be, for example, prospective practitioners who have little or no experience in performing risk analysis processes.

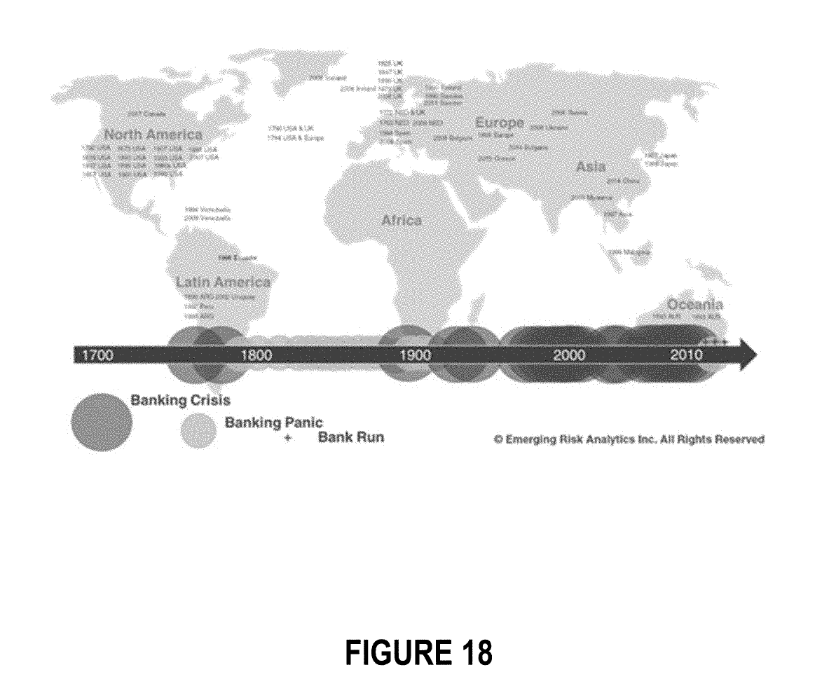

For example, by examining past financial crises, users responsible for performing risk analysis processes on behalf of financial institutions can better understand how to prepare for future financial crises. As shown in FIG. 18, the risk management platform may maintain a record of 59 major and moderate financial crises from 1763 to 2017. These financial crises have occurred in various countries, affected various industries, etc. For example, the visual representation of FIG. 18 includes the Great Depression that took place during the 1930s, the Japanese asset price bubble that took place during the 1980s, the savings and loan crisis that took place during the 1990s, and the subprime mortgage crises that took place during the 2000s. The risk management platform allows users to apply a variety of risk control measures while experiencing various economic scenarios to discover which risk control measures help entities reduce losses, avoid risks, etc.

The risk management platform can also provide users with an “arena” for simulating the performance of entities such as financial institutions. In some embodiments, these users (also referred to as “trainees”) can act as high-level decisionmakers for fictional financial institutions that compete with one another. By making strategic decisions on risk capital allocation, these trainees can lead the fictional financial institutions through various economic scenarios to see which fictional financial institution can obtain the highest investment returns. In some embodiments, the risk management platform is configured to generate a hypothetical financial event based on the library of historical financial events. In other embodiments, the risk management platform is configured to select one of the historical financial events from the library. While embodiments may be described in the context of financial crises, those skilled in the art will recognize that the risk management platform may facilitate simulations involving other types of financial events, such as recessions, bubbles, etc. Accordingly, the risk management platform may ask each trainee to guide their fictional financial institution through, for example, the subprime mortgage crises.

As further described below, after reading a summary of a hypothetical financial crisis, each trainee can adjust the balance of assets and liabilities of their fictional financial institution (e.g., by modifying a fictional balance sheet). Then, the risk management platform can simulate performance of each fictional financial institution (e.g., by predicting cash flow, profit/loss, assets/liabilities, etc.) based on the characteristics of the hypothetical financial crisis. In some embodiments, another user (also referred to as a “practitioner,” “trainer,” or “instructor”) is able to review the performance of the fictional financial institutions and then discuss the performance with the trainees to improve the trainees' understanding of risk management.

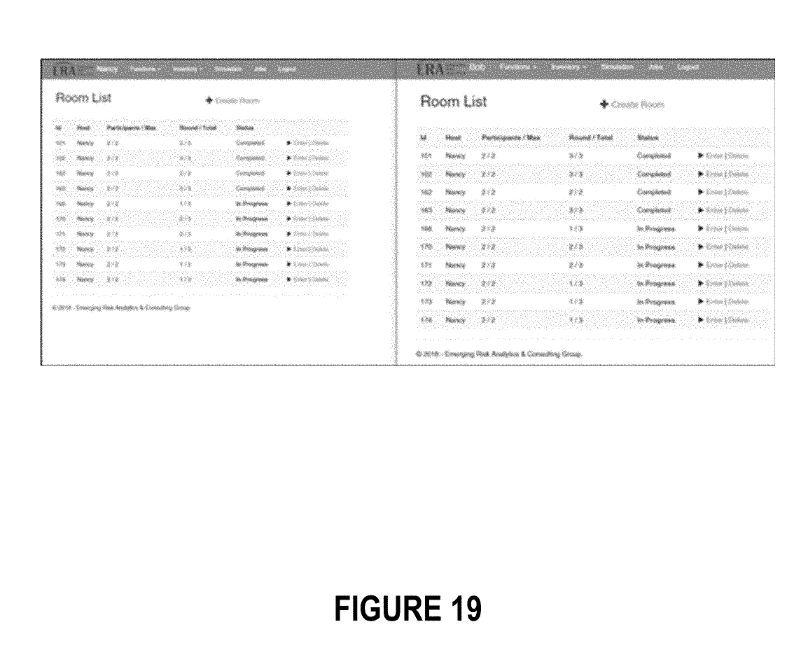

Training may occur through a multiplayer game in which trainees compete against one another. FIG. 19 includes an example of an interface in which two trainees (e.g., Nancy and Bob) simultaneously consider how to guide their respective fictional financial institutions through a fictional financial crisis. Initially, these trainees will access the risk management platform (e.g., by accessing the appropriate domain and then providing credentials). The trainees can then select a graphical element labeled “Risk Training” or “Simulation” to access an interface representative of a lobby. This interface may show simulation sessions (also referred to as “games”) that are presently in progress, the trainees involved in these games, and the status of these games. A trainee may opt to join an existing game that includes at least one other trainee, or the trainee may opt to create a new game.

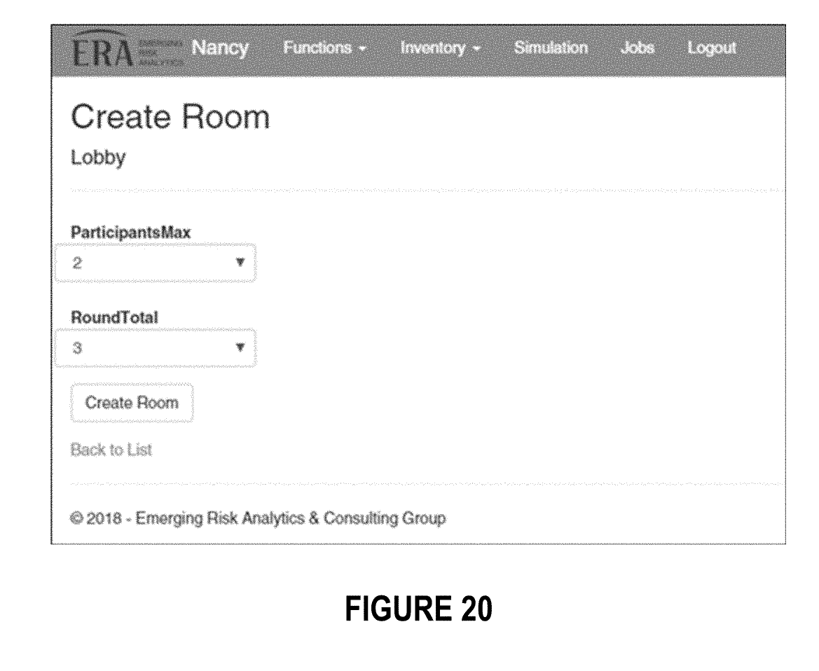

To create a new game, the trainee can select the graphical element labeled “New Game.” Upon receiving input indicative of a selection of the graphical element, the risk management platform may generate an interface that allows the trainee to specify characteristics of the new game, as shown in FIG. 20. For example, the trainee may be prompted to specify the maximum number of participants, minimum number of participants, total number of rounds, etc. Then, the trainee can select the graphical element labeled “Create Room” to initiate the new game.

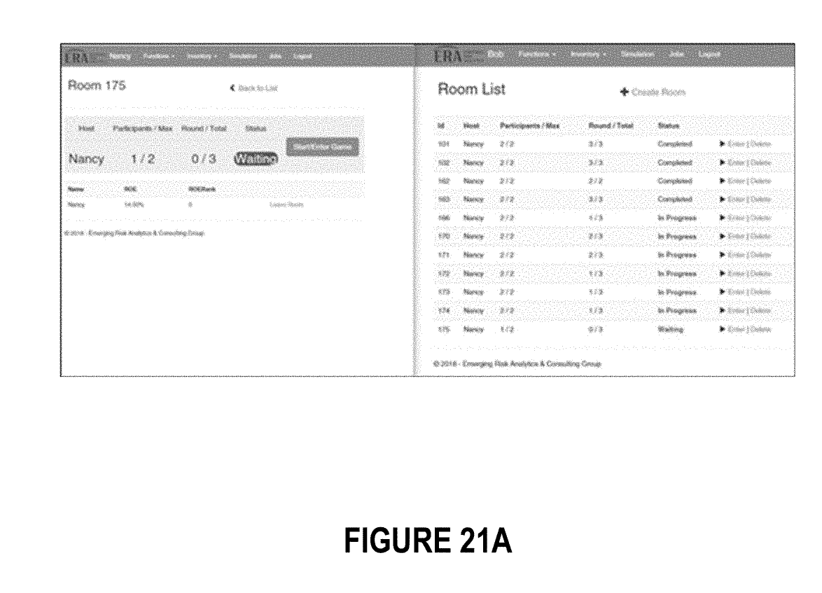

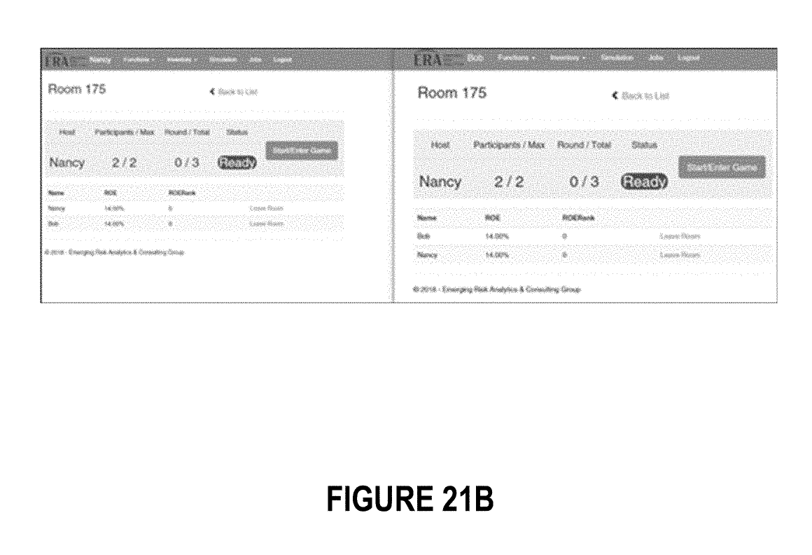

After a first trainee (e.g., Nancy) has initiated a game, the risk management platform may ask the first trainee to wait for other trainee(s) to access the game, as shown in FIG. 21A. The risk management platform may dynamically display the game to other trainees. Here, for example, a second trainee (e.g., Bob) can review whichever game(s) are presently available and then select the game initiated by the first trainee by selecting the graphical element labeled “Enter.” After the number of trainees who have indicated an interest in the game reaches the specified limit, the risk management platform may indicate that the game can begin. For example, the risk management platform may change the status of the game to “Ready,” as shown in FIG. 21B. Moreover, the risk management platform may generate a notification that alerts each trainee the game is ready to begin. To begin the game, each trainer can select the graphical element labeled “Start/Enter Game.”

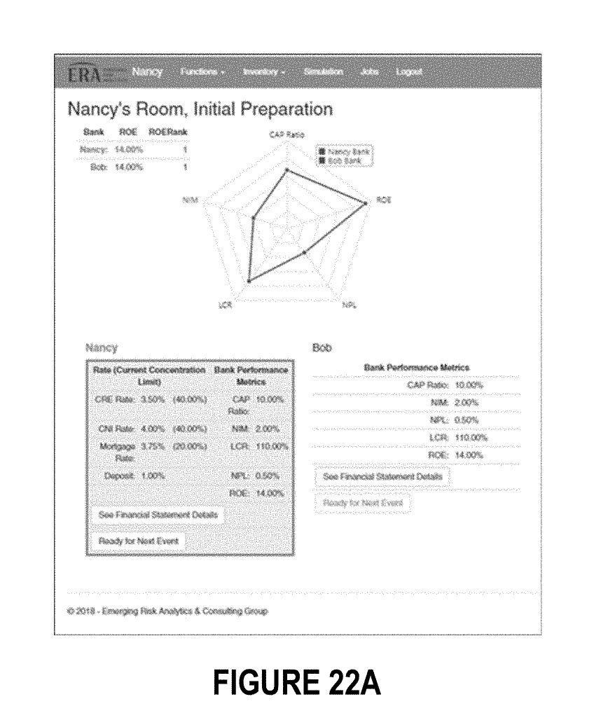

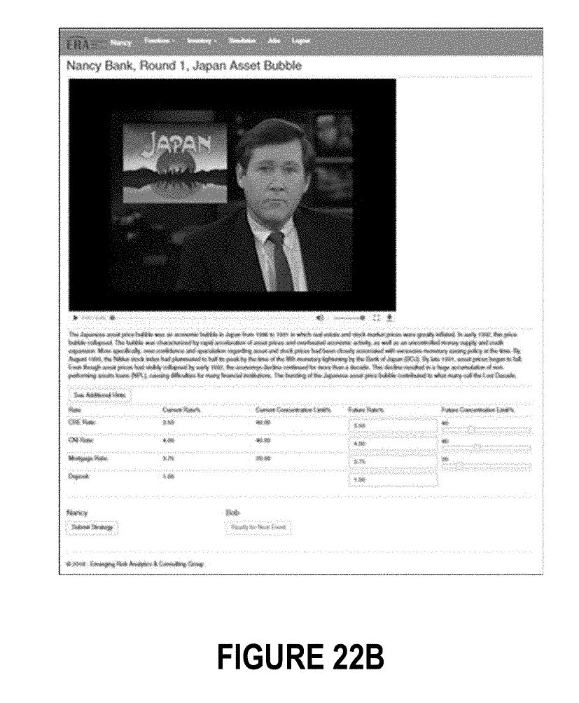

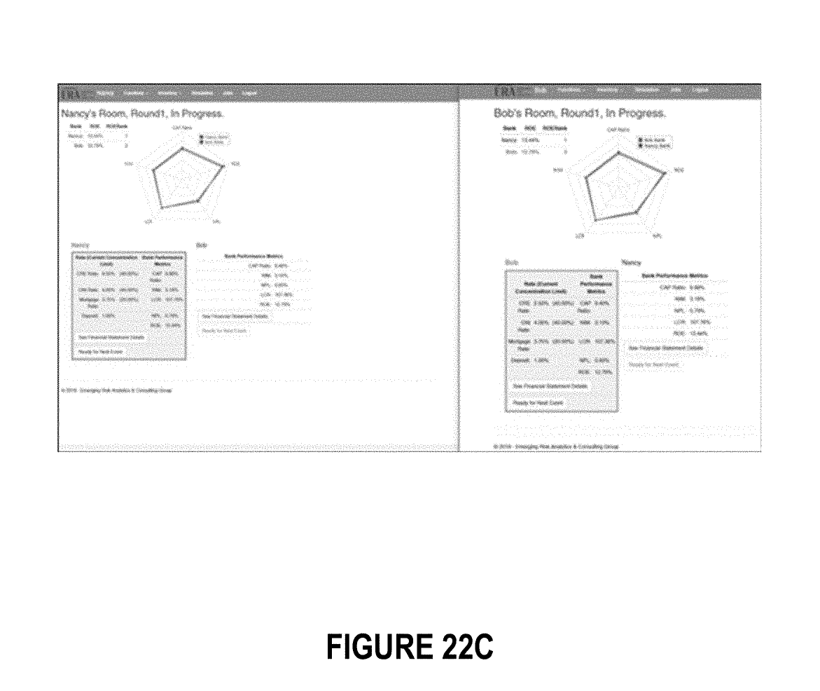

Generally, the game is broken into multiple rounds (e.g., two rounds, three rounds, five rounds). In some embodiments each round is representative of a different stage of a single fictional financial crisis, while in other embodiments each round is representative of a different fictional financial crisis. The number of rounds may be based on the number of participants, the fictional financial crisis, etc. At the beginning of each round, the risk management platform can show several pieces of information to each trainee: (1) the operating indicators of the fictional financial institution controlled by the trainee; (2) the operating indicators of the fictional financial institution(s) controlled by the other trainee(s); and/or (3) the management strategy presently employed by the trainee. FIG. 22A includes an example of an interface that may be shown to a trainee in preparation of the game. In some embodiments, each trainee can browse the balance sheet of their fictional financial institution by selecting the graphical element labeled “See Financial Statement Details.” After the trainees have reviewed/modified the data corresponding to their respective fictional financial institutions, each trainee can select the graphical element labeled “Ready for Next Event” to commence the game.

For each round of the game, the risk management platform can simulate the performance of the fictional financial institutions based on the decisions made by the trainees. As shown in FIG. 22B, several pieces of information regarding the fictional economic crisis may be shown to the trainees during each round. For example, the risk management platform may display multimedia content (e.g., a video) summarizing the fictional financial crisis, a textual description of the fictional financial crisis, etc. Over the course of the game, each trainee can adjust the management decisions of their respective fictional financial institution. A trainee may be able to make these adjustments by altering the values in fields shown on the interfaces of FIGS. 22A-C. For example, the trainee may adjust the current rates assigned to commercial real estate, commercial/industrial loans, or mortgages, future rates assigned to these market segments, current concentration in these market segments, future concentration in these market segments, etc. After making the desired adjustments, each trainee can select the graphical element labeled “Submit Strategy” to proceed to the next round of the game.

The risk management platform can then simulate the performance of the fictional financial institutions based on the adjustments made by the trainees. Thus, the risk management platform can simulate performance of each fictional financial institution during the fictional financial crisis (or multiple fictional financial crises) based on the new management strategy employed by the corresponding trainee. FIG. 22C includes an example of an interface that summarizes the performance of each financial institution with respect to the other financial institution(s) involved in the game. The risk management platform can then automatically move onto the next round in the game.

Simulations performed by the risk management platform may be accurate to an individual loan level, and different models may be used for different asset types to provide trainees with realistic scenarios. For example, in some embodiments, the risk management platform employs an asynchronous parallel processing system with separate algorithms for commercial real estate (“CRE”) loans, commercial and industrial (“CNI”) loans, small loans and microloans, mortgages, automobile loans, credit cards, timed deposits, non-maturity deposits, etc.

### Example Crisis Scenarios

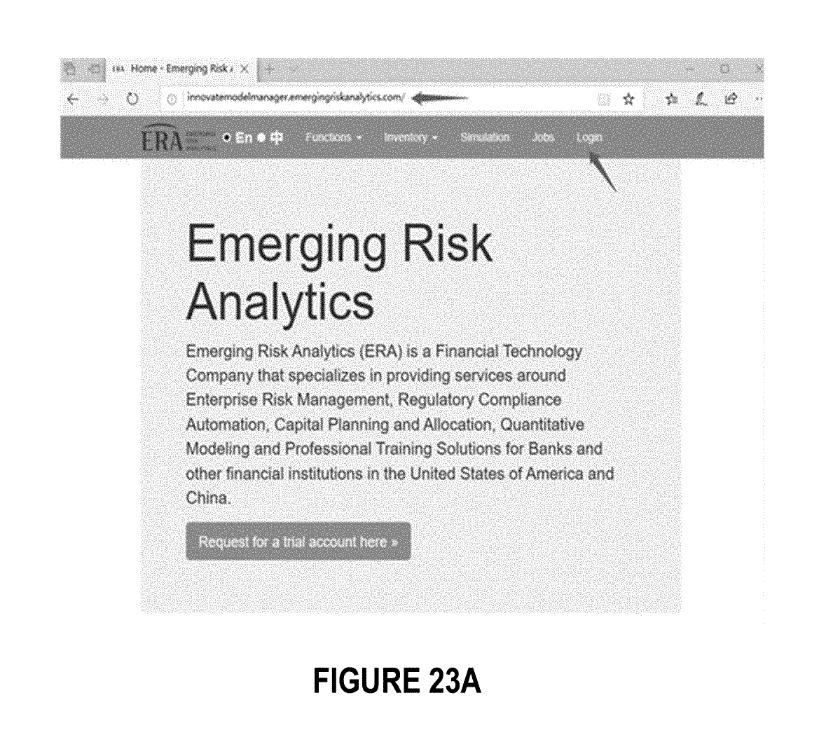

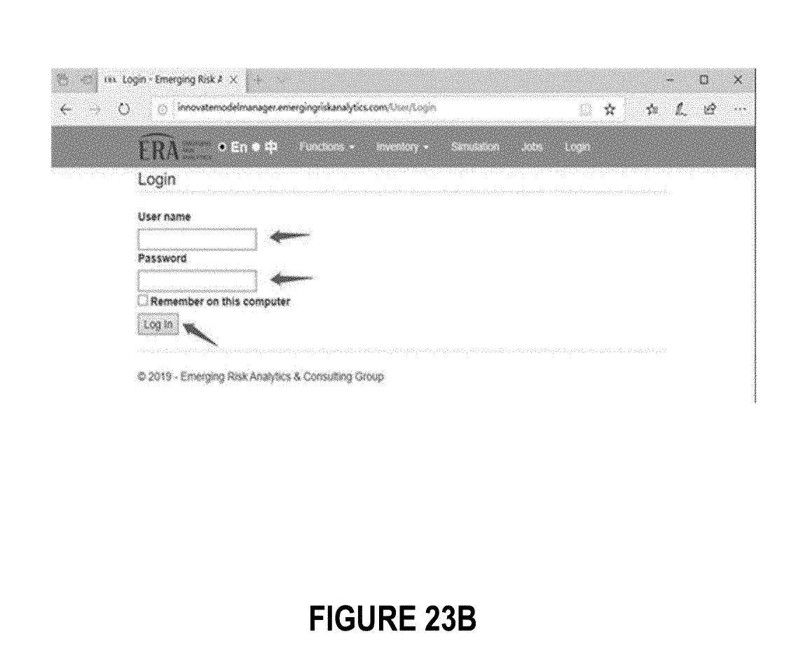

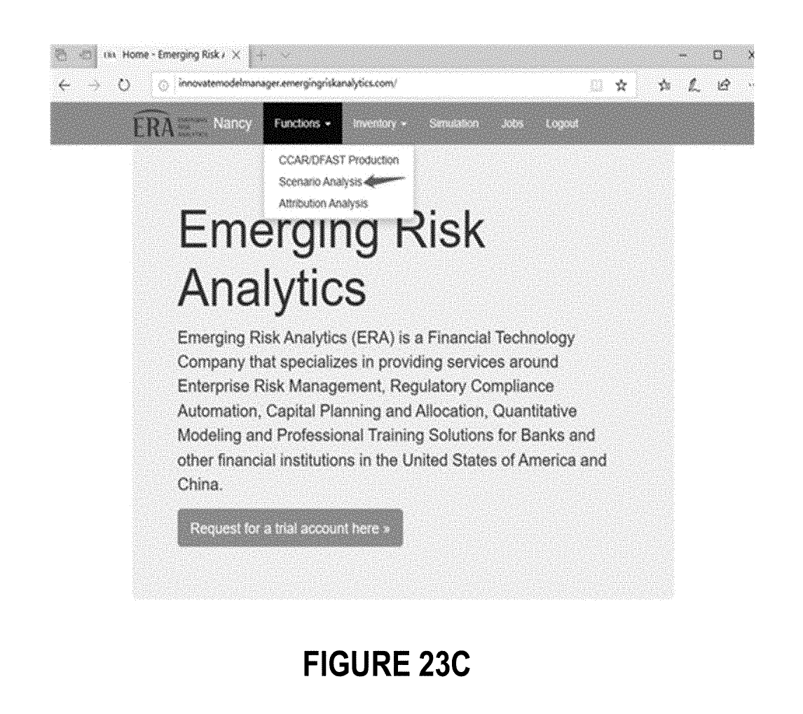

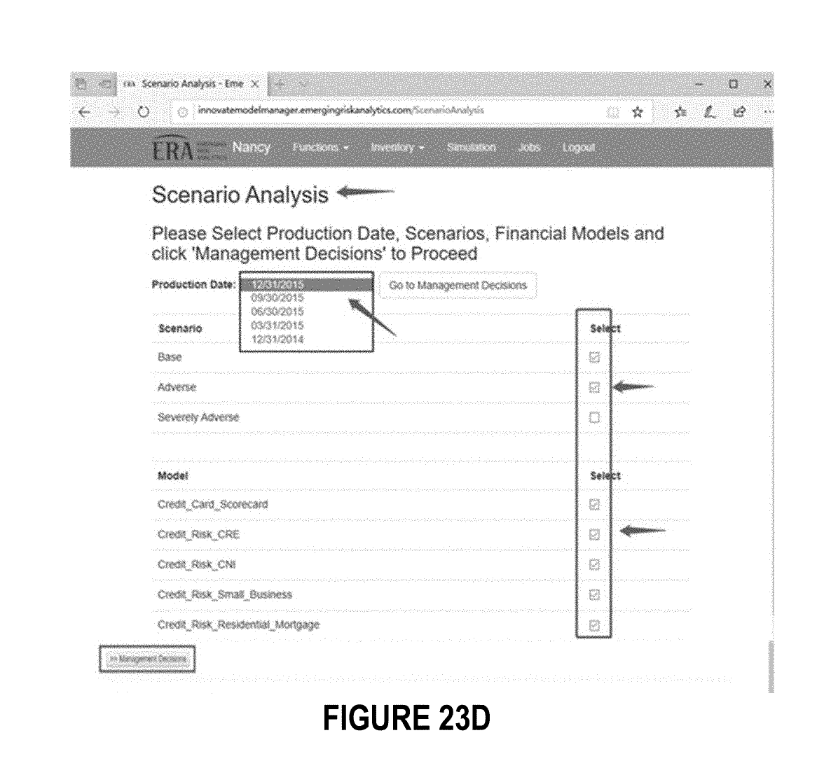

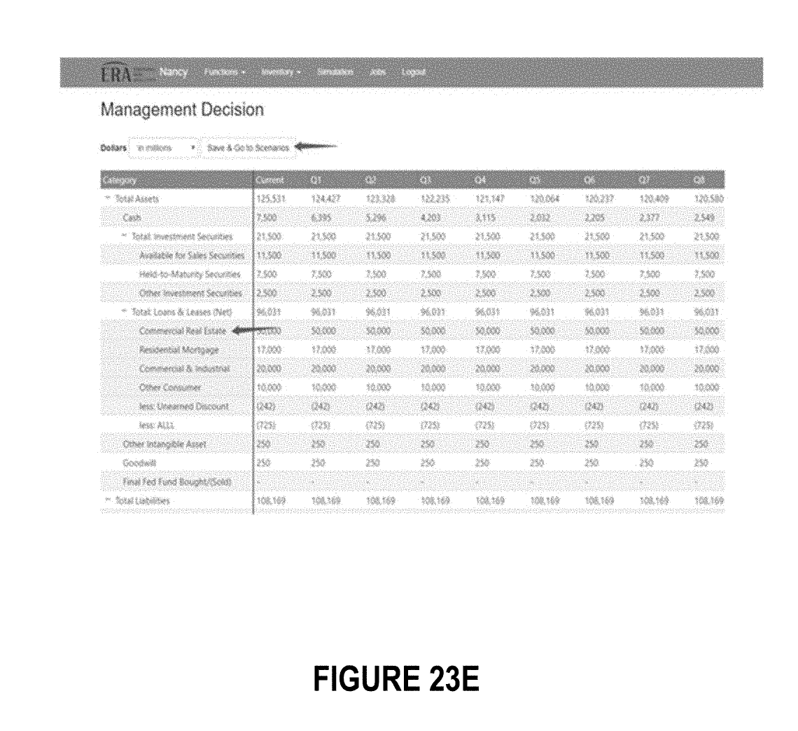

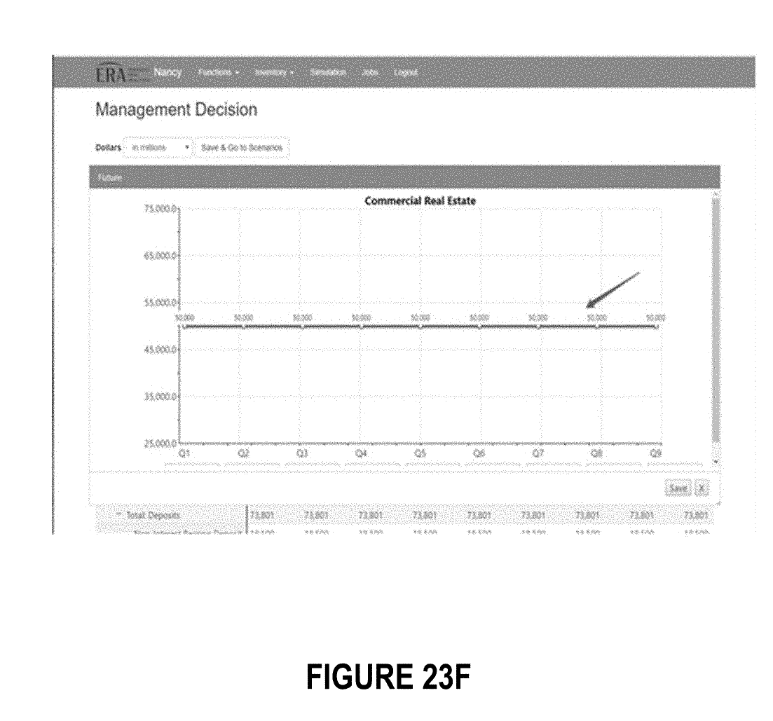

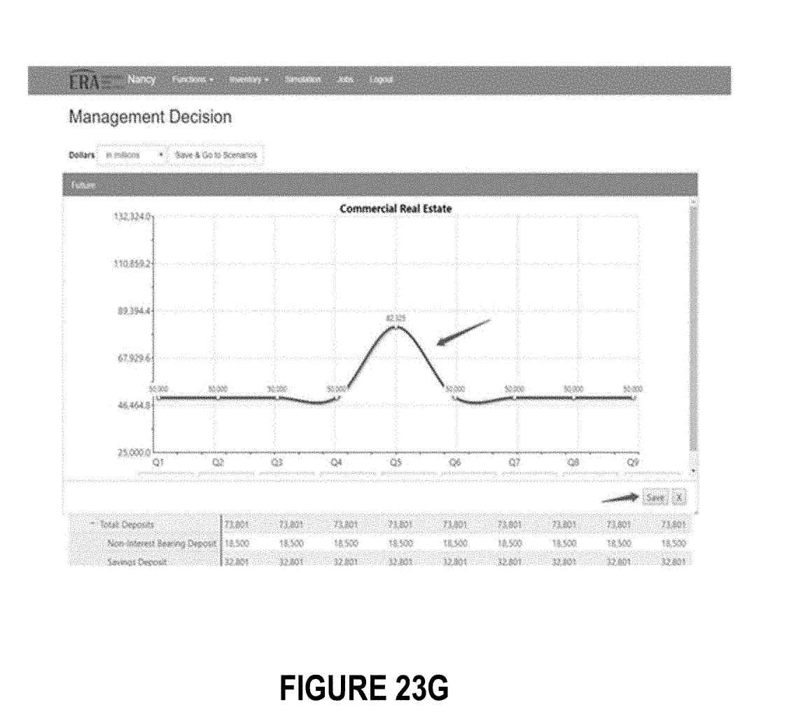

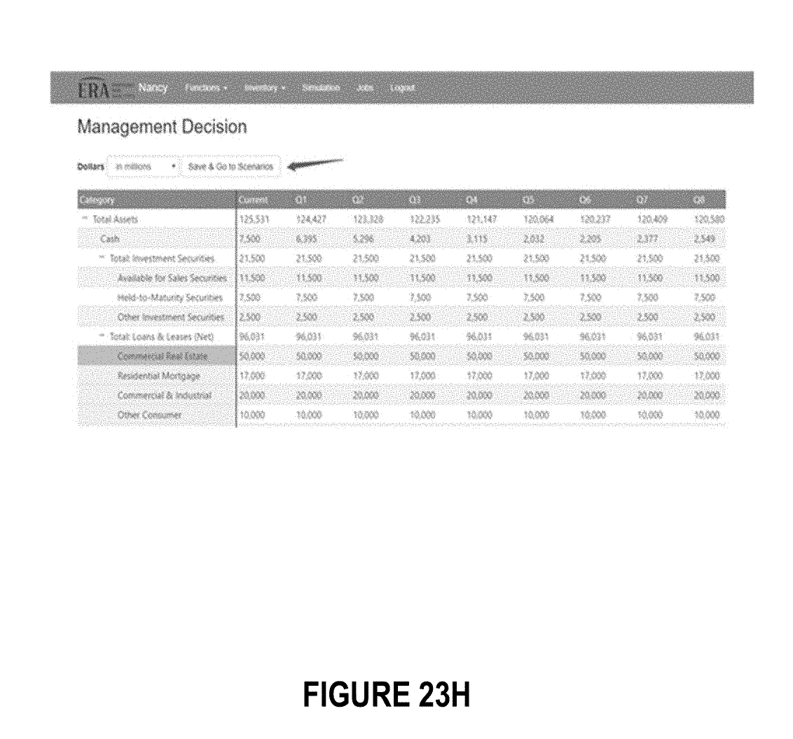

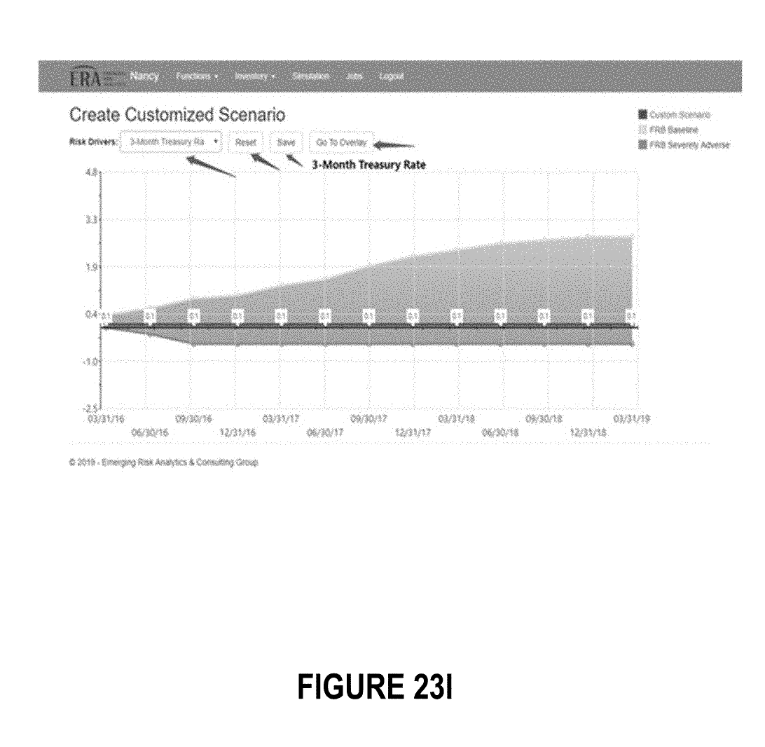

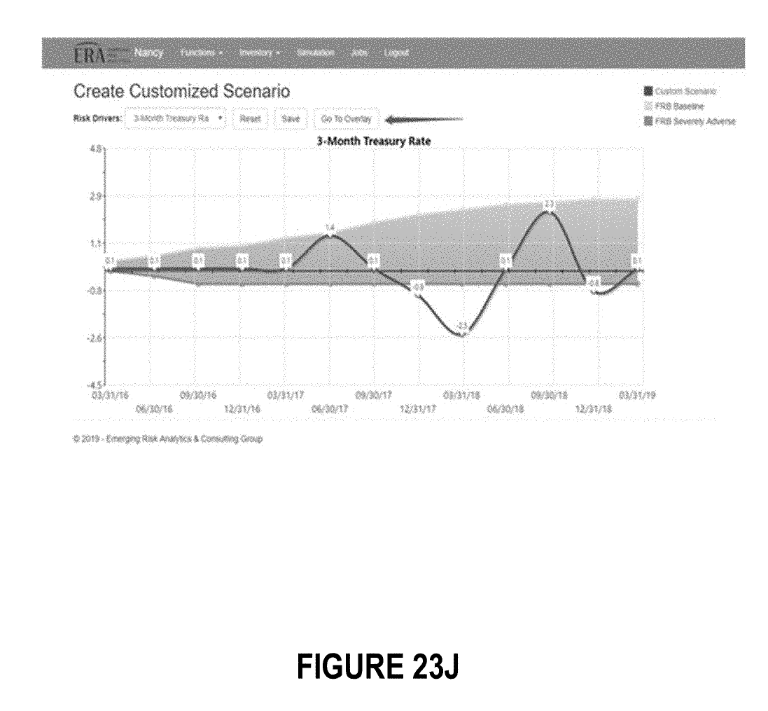

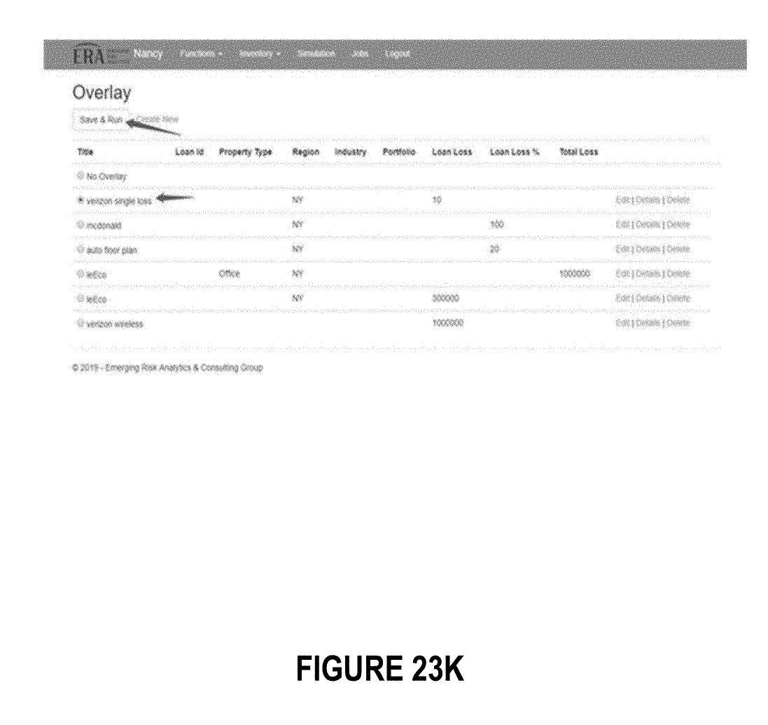

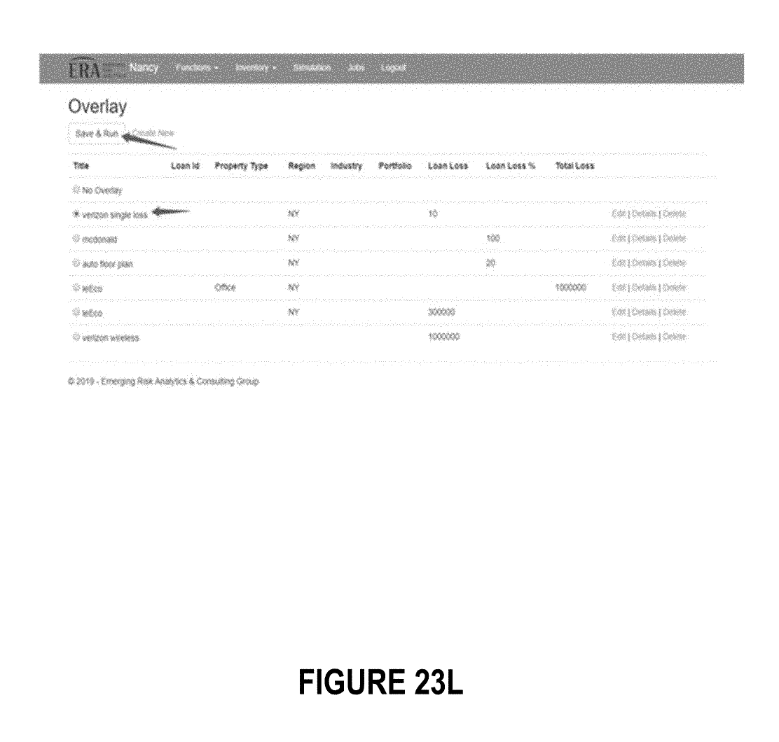

FIGS. 23A-L depict examples of interfaces that may be seen by an individual (John Doe) responsible for executing a risk analysis process on behalf of a financial institution. As shown in FIG. 23A, John Doe can initially open a web browser and navigate to a website managed by a risk management platform. After accessing the website, John Doe can select the graphical element labeled “Login,” and then enter credentials (e.g., a username and password) for the risk management platform, as shown in FIG. 23B. Generally, the credentials are associated with an account, and the risk management platform can determine which feature(s), if any, should be made accessible to John Doe based on the permission level associated with the credentials. For example, upon discovering that John Doe is a non-paying user of the risk management platform, the risk management platform may make a first set of features available. However, upon discovering that John Doe is a paying user of the risk management platform, the risk management platform may make a second set of features available.

To complete a risk analysis process on behalf of a financial institution, John Doe can select the graphical element labeled “Scenario Analysis” under the tab labeled “Functions,” as shown in FIG. 23C. Thereafter, John Doe can set parameters of the risk analysis process. For instance, as shown in FIG. 23D, John Doe may be prompted to choose a production data and then select the scenarios/models on which to conduct sensitivity analysis. After selecting the desired scenarios/models, John Doe can select the graphical element labeled “Management Decisions.” As shown in FIG. 23E, upon selecting the graphical element labeled “Management Decisions,” John Doe may be directed to an interface (also referred to as the “management decision interface”) through which he can alter the portfolio strategy of the financial institution by modifying the balance sheet of the financial institution. John Doe can apply a sensitivity shock to some entries (e.g., the highlighted entries) by double-clicking the corresponding row header. For example, upon double-clicking the row header labeled “Commercial Real Estate,” the risk management platform may present the interface shown in FIG. 23F. Through this interface, John Doe can modify the forecasted balance curve over a future interval of time (here, the next nine fiscal quarters). For example, John Doe may be permitted to drag points along the curve upward/downward, and the risk management platform may automatically fit the curve to the points specified by John Doe. FIG. 23G depicts an example of the post-shock balance curve for the balance sheet entry labeled “Commercial Real Estate.” After finalizing the curve, John Doe can select the graphical element labeled “Save.” As shown in FIG. 23H, such action may cause John Doe to be automatically redirected to the management decision interface.

After finalizing the portfolio strategy of the financial institution, John Doe can select the graphical element labeled “Save & Go to Scenarios” to apply sensitivity to macroeconomic factors that will influence the risk analysis process. As shown in FIG. 23I, upon selecting the graphical element labeled “Save & Go to Scenarios,” John Doe may be directed to an interface (also referred to as a “scenario customization interface”) through which he can customize the economic scenario for which performance of the financial institution will be simulated. Similar to the management decision interface, the scenario customization interface enables John Doe to alter external risk drivers that define the economic scenario. For example, John Doe may be able to select an external risk driver (e.g., from a drop-down menu), alter the corresponding forecasted curve (e.g., by dragging points along the curve upward/downward), and then select the graphical element labeled “Save” to save the altered forecasted curve. In FIG. 23J, for example, John Joe has altered an external risk driver (here, the three-month treasury rate) to experience a minimal value approximately eight fiscal quarters into the future.

After finalizing the sensitivity shock for each external risk driver, John Doe can select the graphical element labeled “Go To Overlay.” As shown in FIG. 23K, John Doe may be directed to an interface (also referred to as an “overlay interface”) through which he can apply an overlay to results produced by risk management platform. These overlays allow John Doe to make targeted modifications to ensure that the results accurately reflect the likely economic state of the financial institution. For example, John Doe may apply an overlay that causes every CRE loan associated with a hotel be given an additional $10,000 in losses on top of the results produced by the risk management platform. As another example, John Doe may apply an overlay that causes residential mortgage revenue to decrease 10%, 15%, or 25% over a predetermined number of fiscal quarters to predict the impact of a recession.

Thereafter, John Doe can select the graphical element labeled “Save & Run.” As shown in FIG. 23L, such action may cause John Doe to be redirected to an interface (also referred to as a “job status interface”) through which he can view the status of different processes, as well as access the results of these processes.

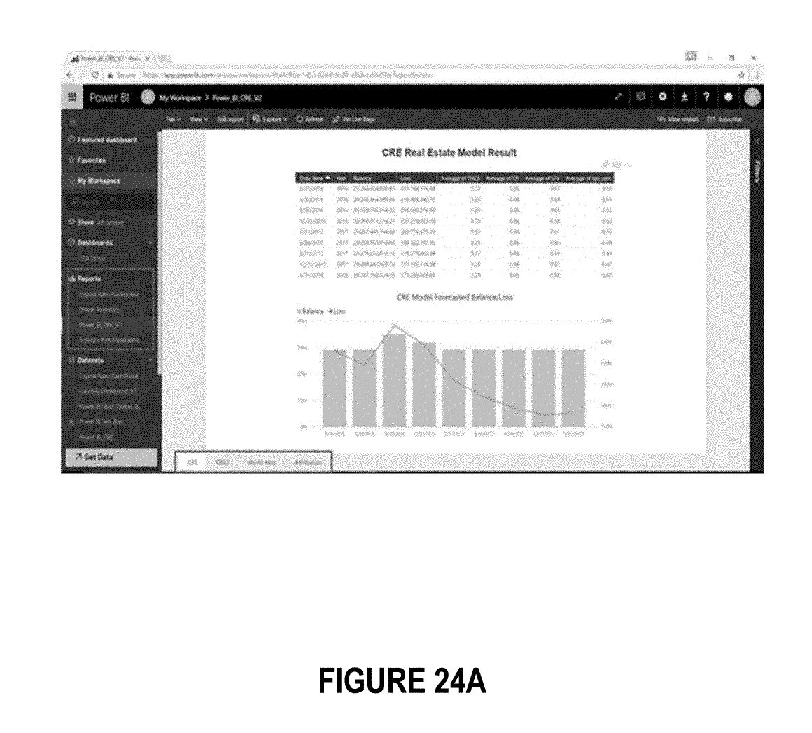

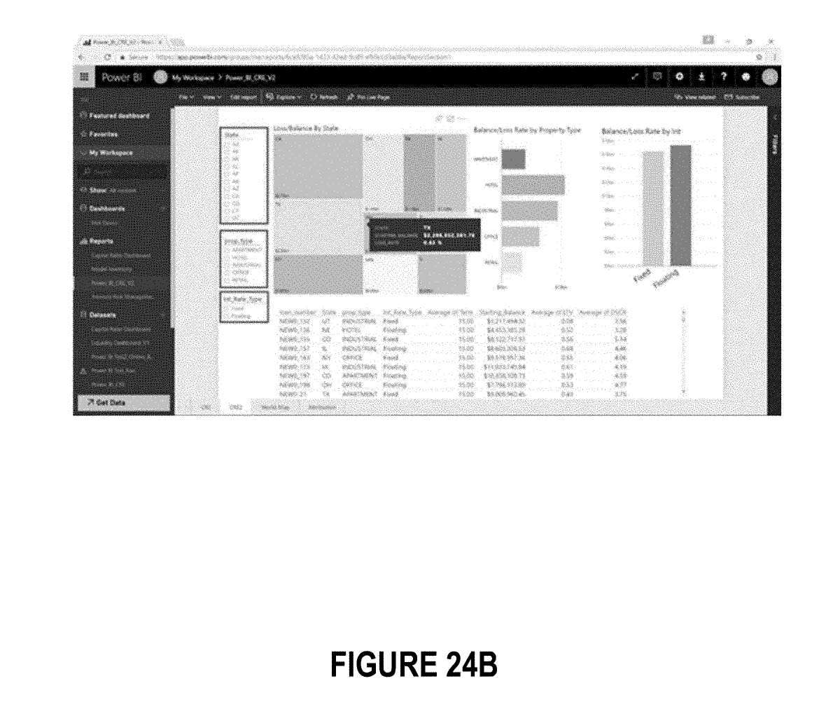

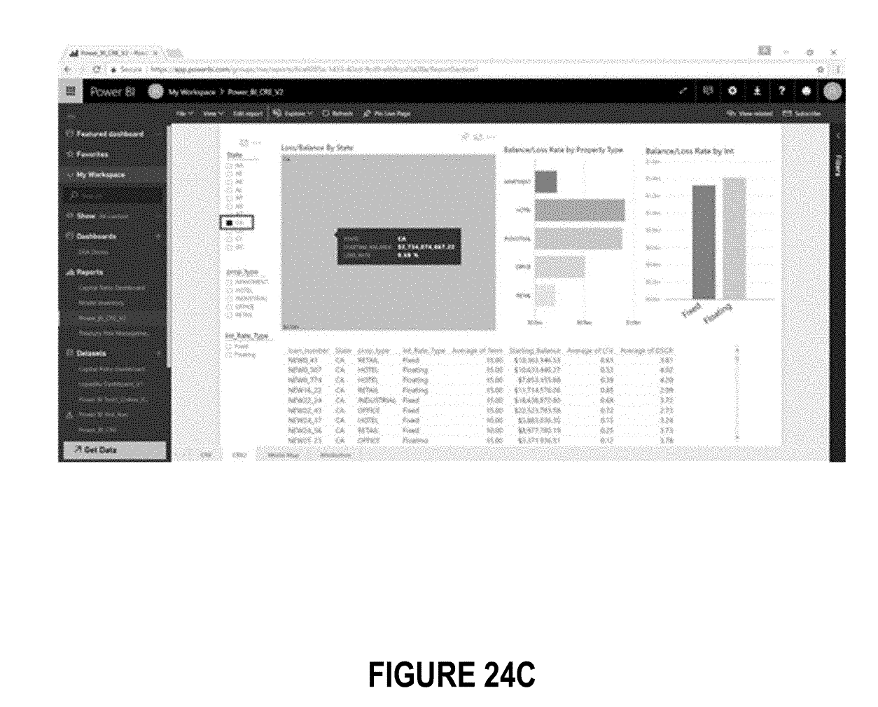

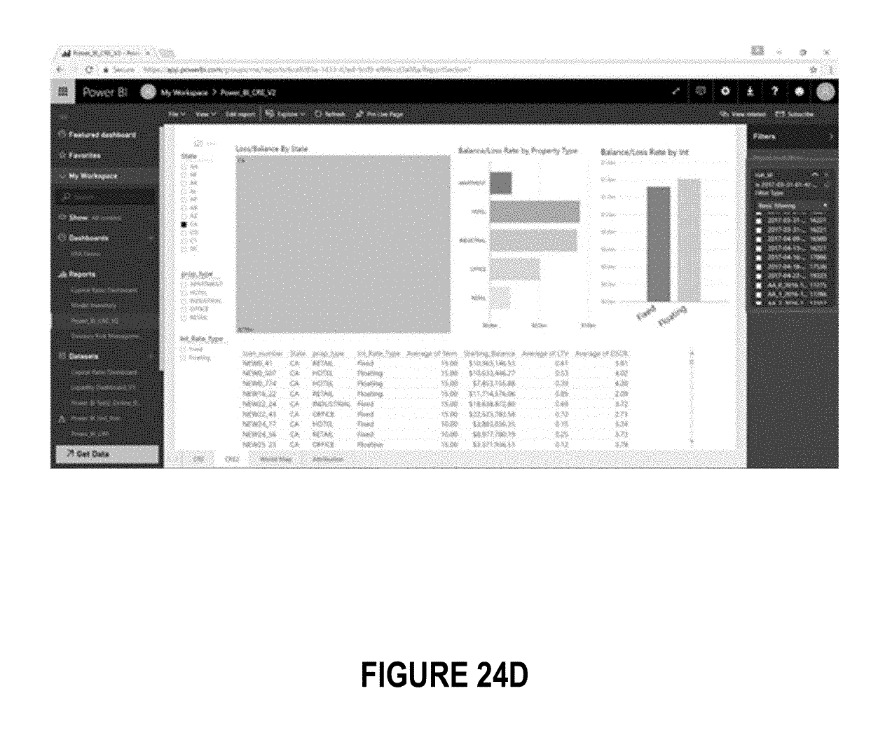

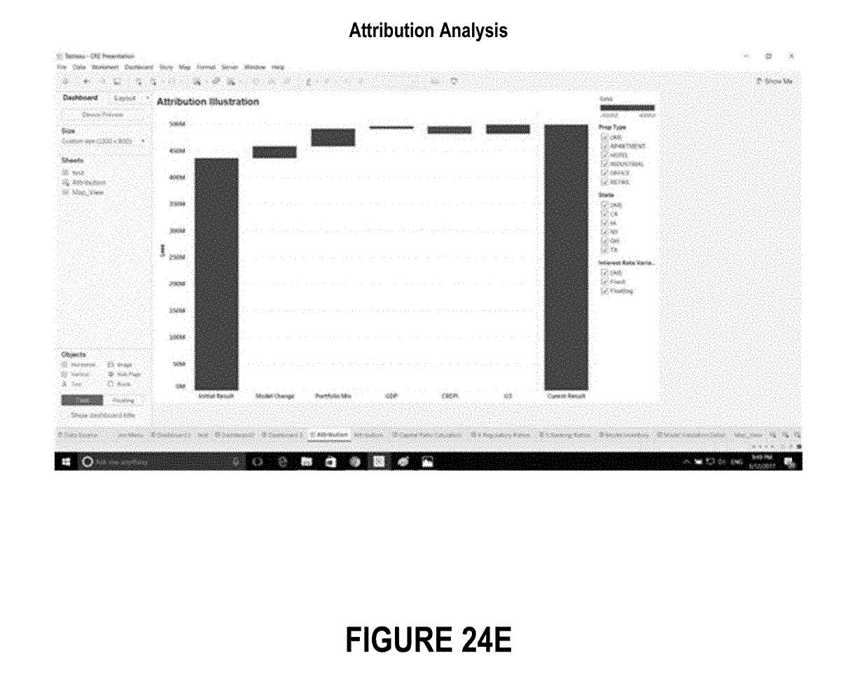

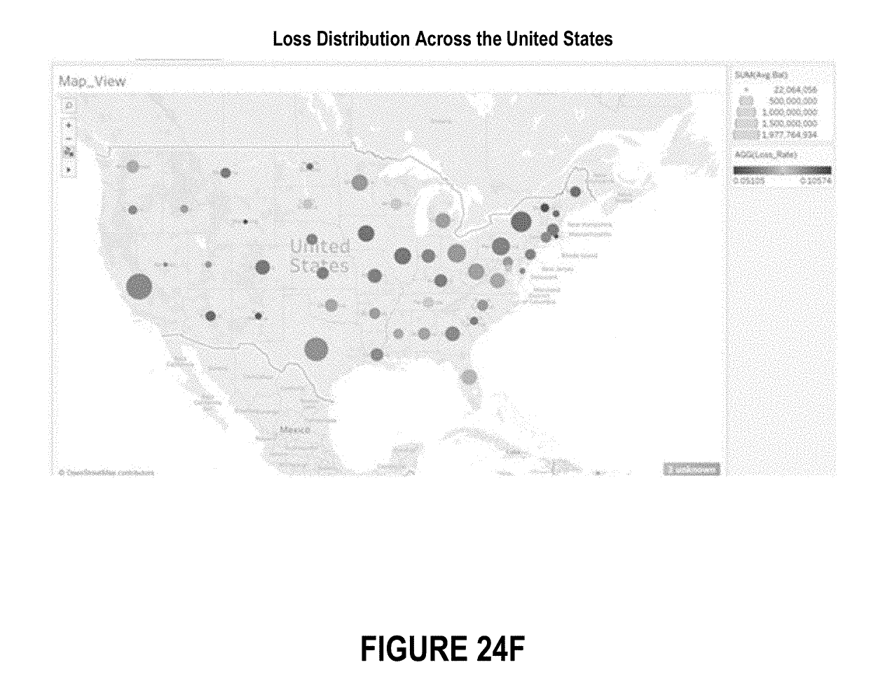

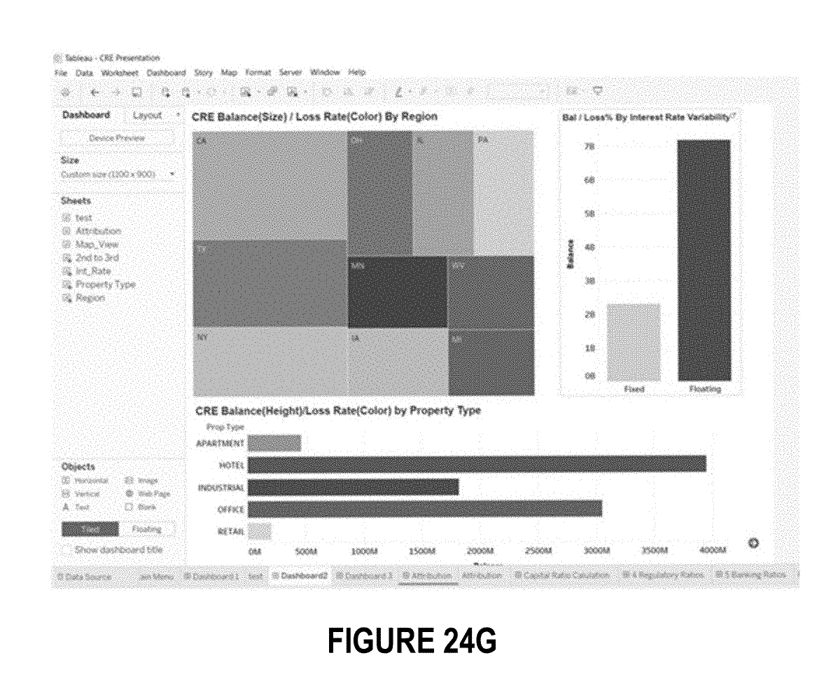

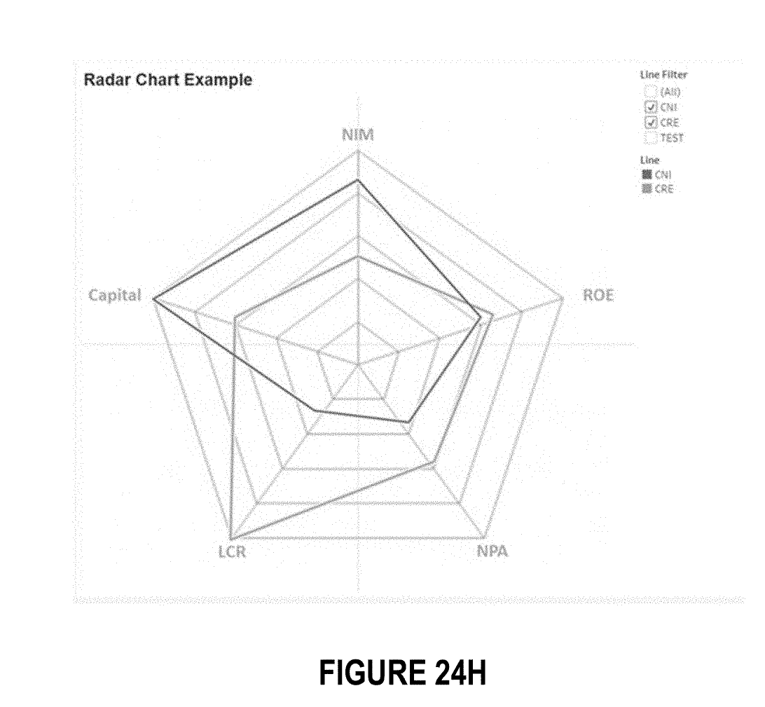

To view the results produced by the risk management platform, John Doe may access business intelligence program (also referred to as a “business intelligence tool”). FIGS. 24A-I, for example, include examples of results that have been made available through Power BI® and Tableau®. John Doe may be able to view different reports/information by interacting with filters available within these interfaces. For instance, as shown in FIG. 24C, if John Doe selects “California” under “State,” the graphs/tables may be automatically updated to reflect information related to California.

### Processing System

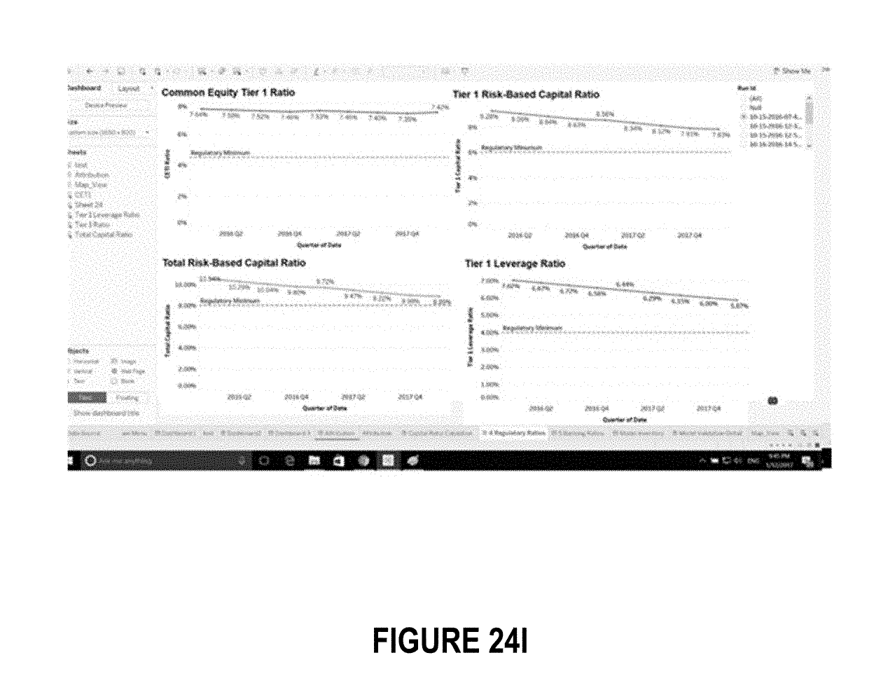

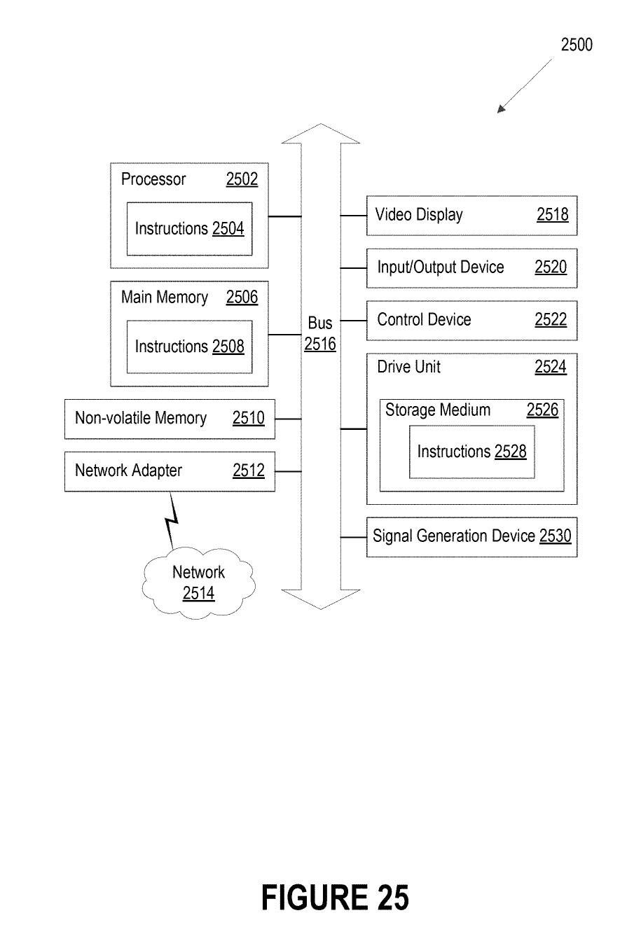

FIG. 25 is a block diagram illustrating an example of a processing system 2500 in which at least some operations described herein can be implemented. For example, some components of the processing system 2500 may be hosted on a computing device that includes a risk management platform (e.g., risk management platform 1002 of FIG. 10).

The processing system 2500 may include one or more central processing units (“processors”) 2502, main memory 2506, non-volatile memory 2510, network adapter 2512 (e.g., network interface), video display 2518, input/output devices 2520, control device 2522 (e.g., keyboard and pointing devices), drive unit 2524 including a storage medium 2526, and signal generation device 2530 that are communicatively connected to a bus 2516. The bus 2516 is illustrated as an abstraction that represents one or more physical buses and/or point-to-point connections that are connected by appropriate bridges, adapters, or controllers. The bus 2516, therefore, can include a system bus, a Peripheral Component Interconnect (PCI) bus or PCI-Express bus, a HyperTransport or industry standard architecture (ISA) bus, a small computer system interface (SCSI) bus, a universal serial bus (USB), IIC (I2C) bus, or an Institute of Electrical and Electronics Engineers (IEEE) standard 1394 bus (also referred to as “Firewire”).

The processing system 2500 may share a similar computer processor architecture as that of a desktop computer, tablet computer, personal digital assistant (PDA), mobile phone, game console, music player, wearable electronic device (e.g., a watch or fitness tracker), network-connected (“smart”) device (e.g., a television or home assistant device), virtual/augmented reality systems (e.g., a head-mounted display), or another electronic device capable of executing a set of instructions (sequential or otherwise) that specify action(s) to be taken by the processing system 2500.

While the main memory 2506, non-volatile memory 2510, and storage medium 2526 (also called a “machine-readable medium”) are shown to be a single medium, the term “machine-readable medium” and “storage medium” should be taken to include a single medium or multiple media (e.g., a centralized/distributed database and/or associated caches and servers) that store one or more sets of instructions 2528. The term “machine-readable medium” and “storage medium” shall also be taken to include any medium that is capable of storing, encoding, or carrying a set of instructions for execution by the processing system 2500.

In general, the routines executed to implement the embodiments of the disclosure may be implemented as part of an operating system or a specific application, component, program, object, module, or sequence of instructions (collectively referred to as “computer programs”). The computer programs typically comprise one or more instructions (e.g., instructions 2504, 2508, 2528) set at various times in various memory and storage devices in a computing device. When read and executed by the one or more processors 2502, the instruction(s) cause the processing system 2500 to perform operations to execute elements involving the various aspects of the disclosure.

Moreover, while embodiments have been described in the context of fully functioning computing devices, those skilled in the art will appreciate that the various embodiments are capable of being distributed as a program product in a variety of forms. The disclosure applies regardless of the particular type of machine or computer-readable media used to actually effect the distribution.

Further examples of machine-readable storage media, machine-readable media, or computer-readable media include recordable-type media such as volatile and non-volatile memory devices 2510, floppy and other removable disks, hard disk drives, optical disks (e.g., Compact Disk Read-Only Memory (CD-ROMS), Digital Versatile Disks (DVDs)), and transmission-type media such as digital and analog communication links.

The network adapter 2512 enables the processing system 2500 to mediate data in a network 2514 with an entity that is external to the processing system 2500 through any communication protocol supported by the processing system 2500 and the external entity. The network adapter 2512 can include a network adaptor card, a wireless network interface card, a router, an access point, a wireless router, a switch, a multilayer switch, a protocol converter, a gateway, a bridge, bridge router, a hub, a digital media receiver, and/or a repeater.

The network adapter 2512 may include a firewall that governs and/or manages permission to access/proxy data in a computer network, as well as tracks varying levels of trust between different machines and/or applications. The firewall can be any number of modules having any combination of hardware and/or software components able to enforce a predetermined set of access rights between a particular set of machines and applications, machines and machines, and/or applications and applications (e.g., to regulate the flow of traffic and resource sharing between these entities). The firewall may additionally manage and/or have access to an access control list that details permissions including the access and operation rights of an object by an individual, a machine, and/or an application, and the circumstances under which the permission rights stand.

The techniques introduced here can be implemented by programmable circuitry (e.g., one or more microprocessors), software and/or firmware, special-purpose hardwired (i.e., non-programmable) circuitry, or a combination of such forms. Special-purpose circuitry can be in the form of one or more application-specific integrated circuits (ASICs), programmable logic devices (PLDs), field-programmable gate arrays (FPGAs), etc.

### EXAMPLES

Several aspects of the technology are set forth in the following examples.

1. A computer-implemented method for facilitating a simulation session in which participants compete against one another by managing the financial strategies employed by fictional entities, the method comprising:
receiving, by a processor, first input indicative of a request submitted by a first participant to initiate a simulation session involving multiple participants;
receiving, by the processor, second input indicative of a request submitted by a second participant to join the simulation session;
causing, by the processor, a first display to present a first interface through which the first participant is able to define a financial strategy of a first fictional entity,
   wherein the first interface includes a first plurality of graphical elements, each graphical element allowing the first participant to specify a different fiscal characteristic of the first fictional entity;
causing, by the processor, a second display to present a second interface through which the second participant is able to define a financial strategy of a second fictional entity,
   wherein the second interface includes a second plurality of graphical elements, each graphical element allowing the second participant to specify a different fiscal characteristic of the second fictional entity;
causing, by the processor, information related to a historical financial event to be posted to the first and second interfaces for review by the first and second participants,
   wherein said causing includes:
      causing multimedia content related to the historical financial event to be presented on the first and second interfaces;
allowing, by the processor, the first and second participants to modify the financial strategies of the first and second fictional entities by interacting with the first and second pluralities of graphical elements;
simulating, by the processor,
   performance of the first fictional entity during the historical financial event based on the financial strategy defined by the first participant, and
   performance of the second fictional entity during the historical financial event based on the financial strategy defined by the second participant; and
causing, by the processor, an output related to the simulated performances of the first and second fictional entities to be posted to the first and second interfaces for review by the first and second participants.
   2. The computer-implemented method of example 1, further comprising:
causing, by the processor in response to receiving the first input, display of an interface through which the first participant is able to specify a characteristic of the simulation session,
   wherein the characteristic is a maximum number of participants, a minimum number of participants, or a total number of rounds.
      3. The computer-implemented method of example 1, wherein said allowing comprises:
permitting the first participant to modify a balance sheet, an investment strategy, or an investment allocation of the first fictional entity through the first interface; and
permitting the second participant to modify a balance sheet, an investment strategy, or an investment allocation of the second fictional entity through the second interface.
   4. The computer-implemented method of example 1, wherein causing the output related to the simulated performances of the first and second fictional entities to be posted to the first and second interfaces for review by the first and second participants includes:
causing a radar chart to be presented on the first and second interfaces, the radar chart including a first trace associated with the first fictional entity and a second trace associated with the second fictional entity.
   5. The computer-implemented method of example 1, wherein the simulation session includes multiple rounds in which the performance of the first and second fictional entities is simulated, and wherein said allowing and said simulating are performed during each round.
   6. The computer-implemented method of example 5, wherein each round corresponds to a different historical financial event through which the first and second fictional entities are guided by the first and second participants.
   7. The computer-implemented method of example 5, wherein each round corresponds to a different stage of the historical financial event through which the first and second fictional entities are guided by the first and second participants.
   8. A computer-implemented method comprising:
causing, by a processor, display of an interface accessible to an individual;
acquiring, by the processor, a programmed model for simulating economic performance uploaded by the individual through the interface;
acquiring, by the processor, financial data associated with an entity from an adapter programmed to obtain the financial data from a source;
receiving, by the processor, first input that specifies a macroeconomic characteristic, a mesoeconomic characteristic, or a microeconomic characteristic of an economic scenario;
altering, by the processor based on the first input, the programmed model to produce an altered model; and
simulating, by the processor, economic performance of the entity in the economic scenario by applying the altered model to the financial data.
   9. The computer-implemented method of example 8, wherein the entity is a financial institution, and wherein the financial data specifies cashflow, holdings in one or more categories, available cash, outstanding loans, or any combination thereof.
   10. The computer-implemented method of example 8, wherein the adapter is an extract-transform-load (ETL) adapter configured to automatically:
extract the financial data from the source;
transform the financial data into a format suitable for processing by the processor; and
load the financial data into a local repository accessible to the processor.
   11. The computer-implemented method of example 8, further comprising:
receiving, by the processor, second input indicative of a request to modify an output produced by the altered model;
identifying, by the processor based on the second input, a modification operation; and
applying, by the processor, the modification operation to the output.
   12. The computer-implemented method of example 8, further comprising:
forwarding, by the processor, an output produced by the altered model to an application programming interface (API) that interfaces with a business intelligence tool,
   wherein the business intelligence tool is configured to, upon receipt of the output, generate a report based on the output.
      13. The computer-implemented method of example 8, further comprising:
loading, by the processor, the financial data, the altered model, and an output produced by the altered model to a local repository accessible to the processor.
   14. The computer-implemented method of example 8, further comprising:
transmitting, by the processor, an output produced by the altered model to a computing device in the form of a spreadsheet or a flat file.
   15. The computer-implemented method of example 14, wherein the computing device is associated with the individual.
   16. An electronic device comprising:
a memory that includes instructions for producing a new extract-transform-load (ETL) adapter customized for a particular programmed model,
wherein the instructions, when executed by a processor, cause the processor to:
   acquire multiple programmed models,
      wherein each programmed model of the multiple programmed models is designed to produce an output representative of predicted performance in an economic scenario based on financial data provided as input;
   create a feature vector for each programmed model of the multiple programmed models, thereby creating multiple feature vectors;
   identify multiple ETL adapters corresponding to the multiple programmed models;
   generate a predictive model by executing a machine learning algorithm that considers the multiple feature vectors and the multiple ETL adapters as input;
   acquire the particular programmed model;
   create a new feature vector for the particular programmed model; and
   produce the new ETL adapter by executing the predictive model that considers the new feature vector as input.
      17. The electronic device of example 16, wherein each feature vector specifies a model category, a script language, a script input parameter, a characteristic of an individual that has employed the corresponding programmed model, or any combination thereof.
      18. The electronic device of example 16, wherein each ETL adapter of the multiple ETL adapters is configured to automatically:
extract financial data from a given source;
transform the financial data into a format suitable for processing by the corresponding programmed model; and
load the financial data into a local repository accessible to the corresponding programmed model.
   19. The electronic device of example 16, wherein the instructions further cause the processor to:
cause display of an interface accessible to an individual;
   wherein the particular programmed model is uploaded by the individual through the interface.
      20. The electronic device of example 16, wherein the multiple programmed models are associated with different entities whose performance is to be simulated.

### Remarks

The foregoing description of various embodiments of the claimed subject matter has been provided for the purposes of illustration and description. It is not intended to be exhaustive or to limit the claimed subject matter to the precise forms disclosed. Many modifications and variations will be apparent to one skilled in the art. Embodiments were chosen and described in order to best describe the principles of the invention and its practical applications, thereby enabling those skilled in the relevant art to understand the claimed subject matter, the various embodiments, and the various modifications that are suited to the particular uses contemplated.

Although the Detailed Description describes certain embodiments and the best mode contemplated, the technology can be practiced in many ways no matter how detailed the Detailed Description appears. Embodiments may vary considerably in their implementation details, while still being encompassed by the specification. Particular terminology used when describing certain features or aspects of various embodiments should not be taken to imply that the terminology is being redefined herein to be restricted to any specific characteristics, features, or aspects of the technology with which that terminology is associated. In general, the terms used in the following claims should not be construed to limit the technology to the specific embodiments disclosed in the specification, unless those terms are explicitly defined herein. Accordingly, the actual scope of the technology encompasses not only the disclosed embodiments, but also all equivalent ways of practicing or implementing the embodiments.

The language used in the specification has been principally selected for readability and instructional purposes. It may not have been selected to delineate or circumscribe the subject matter. It is therefore intended that the scope of the technology be limited not by this Detailed Description, but rather by any claims that issue on an application based hereon. Accordingly, the disclosure of various embodiments is intended to be illustrative, but not limiting, of the scope of the technology as set forth in the following claims.

What is claimed is:

1. A computer-implemented method for facilitating a simulation session in which participants compete against one another by managing the financial strategies employed by fictional entities, the method comprising:
receiving, by a processor, first input indicative of a request submitted by a first participant to initiate a simulation session involving multiple participants;
receiving, by the processor, second input indicative of a request submitted by a second participant to join the simulation session;
causing, by the processor, a first display to present a first interface through which the first participant is able to define a financial strategy of a first fictional entity,
wherein the first interface includes a first plurality of graphical elements, each graphical element allowing the first participant to specify a different fiscal characteristic of the first fictional entity;
causing, by the processor, a second display to present a second interface through which the second participant is able to define a financial strategy of a second fictional entity,
wherein the second interface includes a second plurality of graphical elements, each graphical element allowing the second participant to specify a different fiscal characteristic of the second fictional entity;
causing, by the processor, information related to a historical financial event to be posted to the first and second interfaces for review by the first and second participants,
wherein said causing includes:
causing multimedia content related to the historical financial event to be presented on the first and second interfaces;
allowing, by the processor, the first and second participants to modify the financial strategies of the first and second fictional entities by interacting with the first and second pluralities of graphical elements;
simulating, by the processor,
performance of the first fictional entity during the historical financial event based on the financial strategy defined by the first participant, and
performance of the second fictional entity during the historical financial event based on the financial strategy defined by the second participant; and
causing, by the processor, an output related to the simulated performances of the first and second fictional entities to be posted to the first and second interfaces for review by the first and second participants.

2. The computer-implemented method of claim 1, further comprising:
causing, by the processor in response to receiving the first input, display of an interface through which the first participant is able to specify a characteristic of the simulation session,
wherein the characteristic is a maximum number of participants, a minimum number of participants, or a total number of rounds.

3. The computer-implemented method of claim 1, wherein said allowing comprises:
permitting the first participant to modify a balance sheet, an investment strategy, or an investment allocation of the first fictional entity through the first interface; and
permitting the second participant to modify a balance sheet, an investment strategy, or an investment allocation of the second fictional entity through the second interface.

4. The computer-implemented method of claim 1, wherein causing the output related to the simulated performances of the first and second fictional entities to be posted to the first and second interfaces for review by the first and second participants includes:
causing a radar chart to be presented on the first and second interfaces, the radar chart including a first trace associated with the first fictional entity and a second trace associated with the second fictional entity.

5. The computer-implemented method of claim 1, wherein the simulation session includes multiple rounds in which the performance of the first and second fictional entities is simulated, and wherein said allowing and said simulating are performed during each round.

6. The computer-implemented method of claim 5, wherein each round corresponds to a different historical financial event through which the first and second fictional entities are guided by the first and second participants.

7. The computer-implemented method of claim 5, wherein each round corresponds to a different stage of the historical financial event through which the first and second fictional entities are guided by the first and second participants.

8. A computer-implemented method comprising:
causing, by a processor, display of an interface accessible to an individual;
acquiring, by the processor, a programmed model for simulating economic performance uploaded by the individual through the interface;
acquiring, by the processor, financial data associated with an entity from an adapter programmed to obtain the financial data from a source;
receiving, by the processor, first input that specifies a macroeconomic characteristic, a mesoeconomic characteristic, or a microeconomic characteristic of an economic scenario;
altering, by the processor based on the first input, the programmed model to produce an altered model; and
simulating, by the processor, economic performance of the entity in the economic scenario by applying the altered model to the financial data.

9. The computer-implemented method of claim 8, wherein the entity is a financial institution, and wherein the financial data specifies cashflow, holdings in one or more categories, available cash, outstanding loans, or any combination thereof.

10. The computer-implemented method of claim 8, wherein the adapter is an extract-transform-load (ETL) adapter configured to automatically:
extract the financial data from the source;
transform the financial data into a format suitable for processing by the processor; and
load the financial data into a local repository accessible to the processor.

11. The computer-implemented method of claim 8, further comprising:
receiving, by the processor, second input indicative of a request to modify an output produced by the altered model;
identifying, by the processor based on the second input, a modification operation; and
applying, by the processor, the modification operation to the output.

12. The computer-implemented method of claim 8, further comprising:
forwarding, by the processor, an output produced by the altered model to an application programming interface (API) that interfaces with a business intelligence tool,
wherein the business intelligence tool is configured to, upon receipt of the output, generate a report based on the output.

13. The computer-implemented method of claim 8, further comprising:
loading, by the processor, the financial data, the altered model, and an output produced by the altered model to a local repository accessible to the processor.

14. The computer-implemented method of claim 8, further comprising:
transmitting, by the processor, an output produced by the altered model to a computing device in the form of a spreadsheet or a flat file.

15. The computer-implemented method of claim 14, wherein the computing device is associated with the individual.

16. An electronic device comprising:
a memory that includes instructions for producing a new extract-transform-load (ETL) adapter customized for a particular programmed model,
wherein the instructions, when executed by a processor, cause the processor to:
acquire multiple programmed models,
wherein each programmed model of the multiple programmed models is designed to produce an output representative of predicted performance in an economic scenario based on financial data provided as input;
create a feature vector for each programmed model of the multiple programmed models, thereby creating multiple feature vectors;
identify multiple ETL adapters corresponding to the multiple programmed models;
generate a predictive model by executing a machine learning algorithm that considers the multiple feature vectors and the multiple ETL adapters as input;
acquire the particular programmed model;
create a new feature vector for the particular programmed model; and
produce the new ETL adapter by executing the predictive model that considers the new feature vector as input.

17. The electronic device of claim 16, wherein each feature vector specifies a model category, a script language, a script input parameter, a characteristic of an individual that has employed the corresponding programmed model, or any combination thereof.

18. The electronic device of claim 16, wherein each ETL adapter of the multiple ETL adapters is configured to automatically:
extract financial data from a given source;
transform the financial data into a format suitable for processing by the corresponding programmed model; and
load the financial data into a local repository accessible to the corresponding programmed model.

19. The electronic device of claim 16, wherein the instructions further cause the processor to:
cause display of an interface accessible to an individual;
wherein the particular programmed model is uploaded by the individual through the interface.

20. The electronic device of claim 16, wherein the multiple programmed models are associated with different entities whose performance is to be simulated.
